(19) United States
(12) Patent Application Publication
(10) Pub. No.: US 2025/0138912 A1
(43) Pub. Date: May 1, 2025

(54) SYSTEM AND METHOD FOR BUILDING CONNECTORS USING AN INTERACTIVE APPLICATION

(71) Applicant: Airbyte, Inc., San Francisco, CA (US)

(72) Inventors: Michel Tricot, San Francisco, CA (US); Sherif Nada, San Francisco, CA (US); Alexandre Girard, San Francisco, CA (US); Johannes Reuter, San Francisco, CA (US); Lake Mossman, San Francisco, CA (US); Ben Church, San Francisco, CA (US); Brian Leonard, San Francisco, CA (US); Ella Rohm-Ensing, San Francisco, CA (US)

(21) Appl. No.: 18/930,469

(22) Filed: Oct. 29, 2024

Related U.S. Application Data
(60) Provisional application No. 63/595,202, filed on Nov. 1, 2023.

(51) Int. Cl. G06F 9/54; G06F 8/33; G06F 8/34

(52) U.S. Cl. CPC G06F 9/541; G06F 8/33; G06F 8/34

(57) ABSTRACT

A method and system for using an interactive and intelligent tool to generate a connector is disclosed. In some embodiments, the method includes generating one or more first connector builder interfaces to receive user input for creating the connector. The method includes invoking one or more artificial intelligence (AI) models to automatically determine one or more suggestions of configuration parameters used in creating the connector based on the user input. The method also includes generating one or more second connector builder interfaces to present the one or more suggestions of configuration parameters to the user for acceptance or modification. The method includes creating the connector in a connector builder using the configuration parameters. The method further includes generating one or more third connector builder interfaces to enable the user to publish the connector.

### CROSS REFERENCE TO RELATED APPLICATION

This application claims the benefit of U.S. Provisional Patent Application No. 63/595,202, titled “System and Method for Building Connectors using an Interactive Application,” and filed on Nov. 1, 2023, the entire content of which is incorporated by reference herein.

### TECHNICAL FIELD

This disclosure relates to creating an interactive application for generating a connector to increase the visibility of the data integration framework and enhance the connector development and maintenance experience.

### BACKGROUND

Data is an integral aspect of any business because of its significance in tracking metrics, streamlining processes, developing solutions, etc. ETL is a common approach to integrating and organizing data to empower data use in business decisions, which includes extracting data from various sources, transforming data to data models according to business rules, and loading data into a destination data store (e.g., data warehouse). Some current ETL products may be able to build connectors or data pipelines to accelerate the data delivery between certain sources and destinations, but this usually requires time-consuming and error-prone manual operations, difficult debugging and iterations of connector configurations, and offers integration of only a limited number of resources.

Therefore, a data pipeline platform that can reduce operation complexity, increase scalability and flexibility, and facilitate customization is desired.

### SUMMARY

To address the aforementioned shortcomings, a method and a system for using an interactive and intelligent tool to generate a connector that facilitates communications between systems are disclosed herein. The method generates one or more first connector builder interfaces to receive user input for creating the connector. The method invokes one or more artificial intelligence (AI) models to automatically determine one or more suggestions of configuration parameters used in creating the connector based on the user input. The method also generates one or more second connector builder interfaces to present the one or more suggestions of configuration parameters to the user for acceptance or modification, and creates the connector in a connector builder using the configuration parameters. The method further generates one or more third connector builder interfaces to enable the user to publish the connector.

In some embodiments, invoking the one or more AI models allows the connector to be created from at least one of a link to a public document site or an open API specification. To invoke the one or more AI models to automatically determine the one more suggestions of configuration parameters, the method invokes one or more controllers associated with an AI service to identify one or more configuration parameter fields for which each of the one or more controllers is able to determine values based on the user input, populates the values to the identified configuration parameter fields, and presents the one or more suggestions of configuration parameters by providing the populated values on the one or more second connector builder interfaces. In some embodiments, the method performs sequencing and caching to ensure the one or more controllers to function properly. In some embodiments, the method also forks an existing connector to the connector builder, where creating the connector comprises modifying the forked connector. In some embodiments, to generate the one or more third connector builder interfaces to enable the user to publish the connector, the method contributes the connector created in the connector builder to a database. The method also determines whether a connector identifier associated with the connector has been included in the database, and marks the connector as a new connector or an update of an existing connector based on determining whether the connector identifier has been included in the database. In some embodiments, the method further captures a current state of creating the connector and performing synchronization based on the captured state.

In some embodiments, the connector is a low-code connector with reduced manual programming and manipulation of development environment, and the connector is configured to access data from at least one of an application programming interface (API) or a database. In some embodiments, the configuration parameter fields comprise one or more of a base URL, an authentication method, a list of candidate streams, metadata associated with a stream, a pagination strategy for the stream, or a structure of a response for a stream. In some embodiments, the connector is created based on a selection from the user, and the selection includes one of importing a manifest file, loading an existing connector, or starting from scratch.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an example of general flow for creating a connector using a connector builder, according to some embodiments.

FIGS. 2A-2D illustrate an exemplary flow for creating a connector using a connector builder, according to some embodiments.

FIG. 3 illustrates an exemplary output user interface for testing requests, according to some embodiments.

FIGS. 4A and 4B illustrate exemplary components of a stream testing side panel, according to some embodiments.

FIG. 5 illustrates an exemplary execution plan in UI-based configuration and testing, according to some embodiments.

FIG. 6 illustrates an architecture overview of an AI assist subsystem that provides AI assist features.

FIGS. 7A-7C illustrate exemplary graphical user interfaces (GUIs) for AI-assistant connector creation, according to some embodiments.

FIGS. 8A and 8B illustrate exemplary GUIs for forking an existing connector, according to some embodiments.

FIGS. 9A-9D illustrate an exemplary flow for contributing a connector, according to some embodiments.

FIG. 10 illustrates an exemplary flowchart for creating a connector using an AI assist subsystem, according to some embodiments.

FIG. 11 illustrates a block diagram of an example computer system that may be used in implementing the technology described herein, according to some embodiments.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

A connector is a tool or component that facilitates communications between various systems (e.g., software applications), which includes functions used to extract, transform, and load data (e.g., authentication, endpoint management). Using existing ETL platforms, developers may create a few data pipelines or connectors. However, this process has many drawbacks. Existing platforms may offer a certain number of integrations with well-regarded sources such as Stripe® and Salesforce®, but there is a gap in the current platforms that leaves out integrations of small services. When a connector is not supported by ELT solutions, e.g., a niche SaaS tool used by a marketing team, an enterprise may have to build and maintain a particular connector to extract data (e.g., from the SaaS). Such integration with an application programming interface (API) may take weeks to accomplish for a developer, but there are integration needs for thousands of such APIs, which is extremely difficult if not impractical. When creating a connector, a large amount of custom coding is needed. Even a developer (not an ordinary user) has to be familiar with different software languages to create connectors that meet different needs. A lack of visibility to existing ETL platforms prevents developers and enterprises from scaling their systems without having to build and maintain the same types of pipelines, which is redundant and unnecessary.

The present disclosure offers an open-source data integration platform that provides hundreds of pre-built and custom connectors to many small services. In some embodiments, the present disclosure provides a connector development kit (CDK) to automate non-specific code and allow enterprises to build and maintain unique connectors for different use cases. The present disclosure builds and maintains open-source data connectors such that users can benefit from each other's custom, unique connectors. The present connectors may also be encapsulated in containers (e.g., Docker® containers) for independent operations to allow easy connector monitoring and update.

Specifically, the present platform describes systems and methods that generate a connector using an interactive and intelligent tool. A connector defines the functionalities such as how to access an API or a database and how to extract records from responses, and can be used to integrate different systems and services. The connector described herein may include a low-code connector. The “low-code” indicates that the amount of code/programming needed to implement an API connector is reduced. An interactive tool may include one or more graphical user interfaces (GUIs). One or more artificial intelligence (AI) tools/models may also be applied to increase efficiency and accuracy in connector creation with minimized manual operations.

Advantageously, the present platform creates an intuitive, graphical interface to build and maintain connectors (e.g., low-code connectors), which provides a technical solution to the technical problems described hereafter. Most API connectors are formulaic enough that writing custom code for these connectors can be unnecessarily complex and time-consuming. A developer has to write a lot of code that defines a connector. This requires a non-trivial amount of knowledge about data integrations, data extractions, data processing, and error handling. Additionally, using existing data integration platforms, it is difficult to debug and iterate on a connector code. The feedback loop is usually slow and requires a significant amount of back-and-forth communications (e.g., context switching between a text editor and a terminal). In some cases, while troubleshooting information may be available as logs in response to running a command (e.g., a read command), it can be very difficult to parse and interpret the log to extract the needed information.

API connectors typically perform similar sets of functions such as authentication, pagination, rate limiting, incremental data exports, decoding & structuring the responses into a reasonable schema, filtering or transforming the output, etc., in a limited number of ways. Based on analyzing the functions, parameters, commands, and data exchanges between various components for numerous API connectors, the present platform may allow users to build connectors in a leveraged way that is much higher than coding. In some embodiments, the present platform may generate a unified platform to provide users with visibility and insights into the underlying platform and to empower the users to work independently without having to code or manipulate the development environment. This allows the users to bypass costly development, testing, and release cycles, thereby significantly reducing the users' burden in creating and maintaining (e.g., testing, sharing) the connectors. In some embodiments, the present platform may include an interactive and graphical tool (e.g., a connector builder as described below). For example, a user may simply select an option (e.g., by clicking a button or a tab) in a GUI of the connector builder to choose appropriate source and destination platforms and get authenticated to create his/her pipeline to move the needed data.

Additionally or alternatively, the present system may use AI assist subsystem and user connector contribution feature to further benefit the connector building process. Using AI to build an API connector may allow quick code generation (e.g., boilerplate code) to reduce development time and automate repetitive tasks such as error handling and data formatting, thereby enhancing the system's efficiency. AI can help improve the system's accuracy through error reduction and data validation. The AI assist subsystem can also be used to quickly generate functional prototypes to test concepts and gather feedback without extensive manual coding. The user connector contribution feature also allows a new connector to be created based on an existing connector, thus reducing repetitive tasks and development time, and minimizing errors. The AI and user connector contribution features can also be used to help create clear and concise documentation, making it easier for other developers to understand and use the connector; analyze data from the API, providing insights that can help optimize performance or enhance functionality; and analyze API changes and adapt the connector accordingly, reducing maintenance effort, etc.

In general, the present disclosure may create an intuitive interface that guides users through an entire process of integration implementation, and ensures the users have the required visibility into the system when efficiently and effectively creating and maintaining the low-code connectors. As a result, the present disclosure benefits of increasing the visibility/observability of the data integration framework, reducing operation complexity, increasing scalability and flexibility, facilitating customization, enhancing user experience, etc.

### Technical Development & Solution

A user or developer's first-time experience in building a connector with a connector development kit (CDK) is critical. If the user finds it difficult to go through his/her first connector, he/she would likely not be interested in building another connector for future needs. The present disclosure proposes a differentiator tool that helps retain connector developers.

### Low-Code Connector

A connector describes the functionalities to access an API/database and to request and extract data. A low-code or config-based connector a connector created without user writing a lot of code. By lowering the amount of code needed to implement an API connector, low-code connectors have the potential to both grow the long tail of integrations the platform supports and make it easier to maintain these connectors. In some embodiments, a low-code connector may be created through a declarative approach using human-readable configuration files (e.g., YAML Ain′t markup language (YAML) configuration files) to describe the source and utilizing a cloud development kit (CDK) (e.g., Python CDK) to run the connector. YAML configuration files allow data to be organized hierarchically to adapt to complex configurations. As a result, moving data from any database or business application to a destination may rely on only a few clicks.

However, there are still areas of improvement in this new way of building connectors. For example, handwriting YAML files without autocomplete and enumeration of options can be difficult, and the debugging/iteration experience is slow and requires many context switching. Specifically, there may be no way for a developer to know how to write the configuration of a low-code API connector without reading Python code, a massive JavaScript object notation (JSON) Schema, or documentation. The developer may need to go through different prototyping systems to test out assumptions about the API, including:
Use cURL+jq to test the functions of hitting an endpoint and extracting records;
Write a stream schema in a text editor;
Write a low-code connector in a text editor;
Try running a read operation through a terminal.

An endpoint includes a specific URL where an API can be accessed. The endpoint may include key components such as a base URL, path, query parameters, HTTP method, etc. The base URL is the root URL of the API. The path indicates the specific resource/action to be requested. The query parameters include optional parameters added to the URL to filter or modify an API request. The HTTP method specifies the action to be performed such as get, post, put, delete. A stream schema typically refers to the structure or format of the data being streamed via the low-code connector between systems.

The above process (e.g., producing stream schema, writing connector) can be extremely tedious and error-prone. Due to the absence of knowledge about a feedback loop, figuring out how to extract the records from responses can also be very difficult.

### Technical Support

### Common Flow for Creating Connector

Conceptually, all API-based connectors are developed by following the same flow:
1. Identify the endpoint to hit;
2. Set up proper authentication;
3. Attempt to fetch data;
4. Determine how to extract relevant data out of a response;
5. Determine how pagination works; and
6. Determine how to support incremental synchronization or syncs.

In some embodiments, each of these steps requires an iteration loop. A loop may include updating the connector, submitting a request, validating an output, etc.

### Schema Generation and Record Extraction

In general, generating a stream schema and determining how to extract records from a response are closely related, which are the two most time-consuming steps in a connector development process. To produce a schema, a developer may need to read through the sample responses in the API documentation, find where in the response the records are, and eventually identify the type of each field. Similarly, to extract the records from a response, the developer needs to determine the exact location of the records in the response.

### Proposed Solution

The present disclosure may provide a user interface to guide users (e.g., developers) through the entire end-to-end connector development process, from the initial attempt at hitting the API, to iteratively developing a connector, and finally to testing and producing the connector.

The present disclosure may allow the connector users (e.g., developers) to develop verifiably production-ready and high-quality API connectors without needing to understand the underlying working mechanism of the CDK. The present disclosure may also allow the connector users (e.g., developers) to generate a connector (e.g., low-code connector) through an interactive and iterative process while minimizing the feedback loop.

In some embodiments, the present disclosure proposes a connector builder user interface (UI). The connector builder UI may provide at least one intuitive UI on top of the low-code configuration files (e.g., YAML format) and the specific CDK (e.g., Python CDK) of the existing system, and use built connectors for synchronization within the same workspace directly from within the UI(s). The connector builder UI is particularly useful when iterating users' low-code connectors.

The connector builder can be applied in various scenarios, for example, when a user wants to integrate with a JSON-based hypertext transfer protocol (HTTP) API as a source of records, or when an API with which the user wants to integrate does not exist yet as a connector in existing integration platforms, etc.

An example high-level flow of using the connector builder is as follows:
1. Access the connector builder in a web application supported by the present platform;
2. Use the connector builder to iterate on a user's low-code connector;
3. Once the connector is ready, publish it to the user's local workspace;
4. Configure a source based on the released connector; and
5. Use the source in a connection to synchronize data.

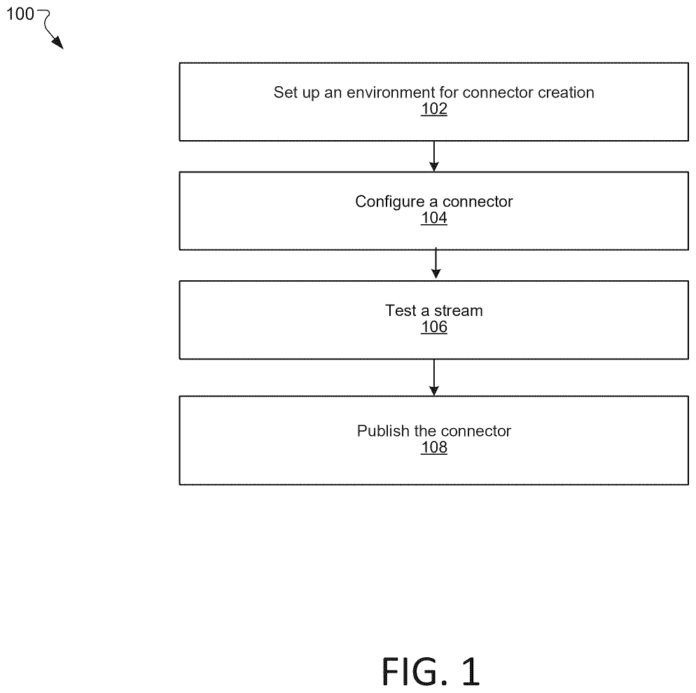

FIG. 1 illustrates an example general flow 100 for creating a connector using a connector builder. Overall, the connector creation flow may include steps of setting up, basic configuration, advanced configuration, and publish and sync. These steps are illustrated for exemplary purposes, and one or more of these steps may be added, deleted, or changed.

At step 102, the present system allows the user to set up an environment for connector creation, for example, launch a connector builder, choose the way to create a connector. At step 104, the connector is configured, for example, identify a uniform resource locator (URL) to which an API request is sent, automate authentication, etc. At step 106, the present system allows the user to set up and test a stream based on API specifications and expected outputs. When developing the connector using a connector builder UI, the present system may allow a current state (e.g., under review, in testing) to be saved in a connector builder project. Each connector builder project may be saved as part of the platform workspace and is separate from the user's source configurations and connections.

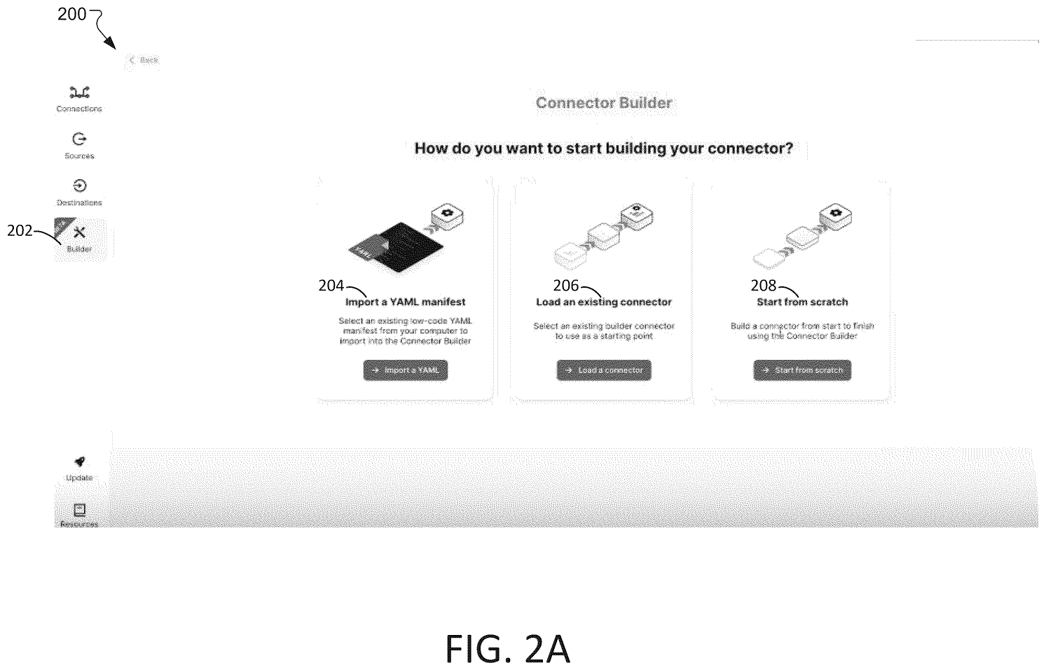

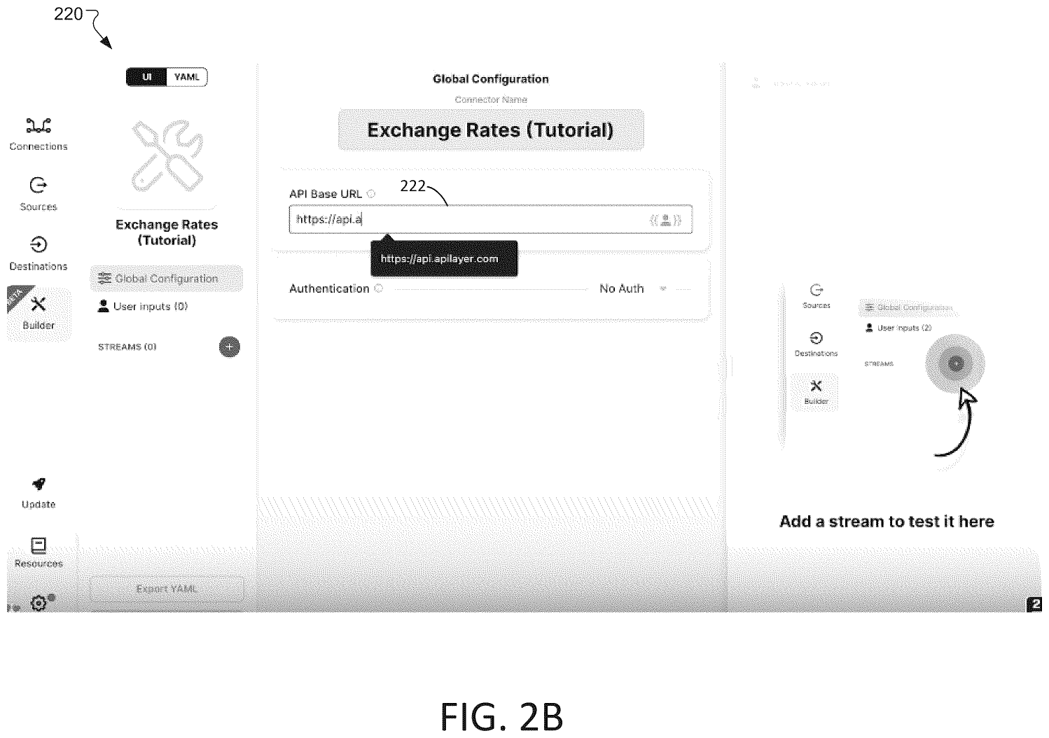

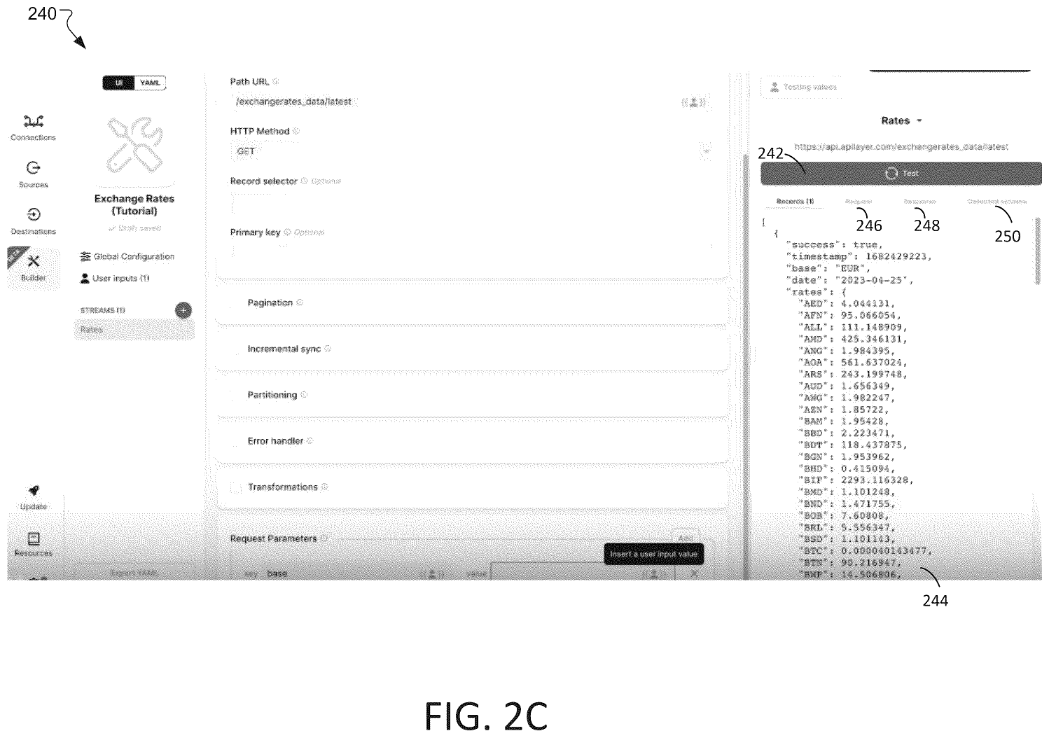

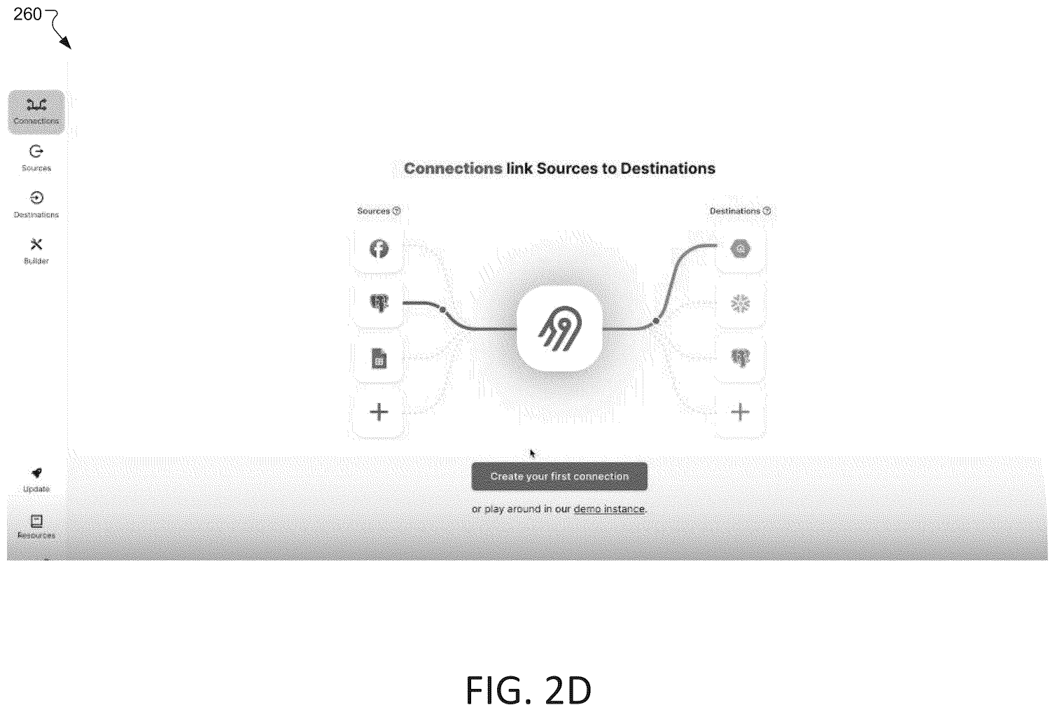

At step 108, the connector is published. The present system may also allow the user to publish the connector builder project to make it available in connections for the purpose of synchronization and for use by other users (e.g., as described in user connector contribution feature described below). These steps 102, 104, 106, and 108 are further detailed below in FIGS. 2A-2D. In some embodiments, each of these steps may be implemented based on specific technical features (e.g., Table 1 below) at different phases.

Referring to FIGS. 2A-2D, these figures illustrate an exemplary flow for creating a connector using a connector builder. The GUIs 200, 220, 240, and 260 respectively shown in FIGS. 2A-2D can guide a user to create a connector in the connect builder in order to read and extract data from an API (e.g., HTTP API). It should be noted the GUIs depicted in FIGS. 2A-2D are mere examples used to illustrate a connector creation process, and different numbers and/or different types of GUIs may be used in the same or different steps for creating a connector using the connector builder.

In the example of FIGS. 2A-2D, a connector reading data from an Exchange Rates API is created, but the steps shown in these figures also apply to other APIs (e.g., HTTP APIs) that a user might be interested in integrating with. The goal in the example of FIGS. 2A-2D is to implement a source connector with a HTTP resource (or “stream”), where the HTTP resource/stream contains exchange rates going from a base currency to many other currencies. The output schema may be similar to the following:

```
{
  “base”: “USD”,
  “date”: “2022-07-15”,
  “rates”: {
    “CAD”: 1.28,
    “EUR”: 0.98
  }
}
```

Before creating the example connector that reads data from the Exchange Rates API (as shown in FIGS. 2A-2D), the present platform allows the user to set up exchange rates API key and environment. For example, the user can set up a browser and a up-to-date running instance in the environment. The process of creating a connector is initiated upon launching a connector builder webpage by the user.

FIG. 2A shows a GUI 200 presented to the user for setting up the process of creating a connector builder project. GUI 200 may be generated in response to the user selecting a “Builder” option 202 from the connector builder webpage. From GUI 200, the user can select how to build a connector. For example, the user may choose to build the connector by importing a YAML manifest 204, loading an existing connector 206, or starting from scratch 208. A YAML manifest file is often used to define the configuration and settings for applications, deployments, or services, particularly in cloud-native environments (e.g., Kubernetes or Kube). Here, the YAML manifest file may define the configuration and parameters required for a connector to function such as metadata of API including authentication methods, endpoints, data types, etc. By selecting 204 or 206, the present system may allow the user to import an existing configuration file or load an existing connector to start the creation of a new connector. In the example of FIG. 2A, the user chooses to start from scratch 208 to build a new connector. The new connector is named as “Exchange Rates (Tutorial)” by the user.

The flow continues to FIGS. 2B and 2C, which provide configuration (e.g., basic configurations) about how to use the connector to extract records from the Exchange Rates API. FIG. 2B includes a “global configuration” UI 220. Using this UI, general settings applying to all streams are configured. For example, the present system may allow the user, within the UI 220, to identify a base URL 222 to which a request is sent and to configure the authentication with an API server associated with the Exchange Rates API.

FIG. 2C includes a UI 240 that allows the user to set up and test a stream. As depicted, a basic stream (e.g., including path URL, HTTP method, etc.) can be configured, and a test request can be sent. In response to a click of a “Test” button 242 from a user, the present system may trigger a test read to simulate what will happen during a synchronization (sync) process. The test result is shown as a single record 244. In a real sync process, the present system may transmit this record to a destination (e.g., a warehouse).

To test the stream, the UI 240 may also include options for request 246, response 248, and/or detected schema 250. The request tab 246 and response tab 248 may help determine which requests and responses the user's connector will send to and receive from the API during development. A detected schema refers to the automatic identification and representation of the data structure/schema used by an API, which is critical to ensure that the connector can accurately communicate with the API and handle data correctly. The detected schema tab 250 may indicate the schema that was detected by analyzing the returned records. In some embodiments, the present system may automatically configure the detected schema as the declared schema for the stream and enable the connector builder to provide the schema for the user to view.

In addition to the setting up (e.g., in FIG. 2A) and basic configurations (e.g., in FIGS. 2B and 2C), the present connector builder may also provide the capability for a user to make certain advanced configuration, such as setting up a second configuration read, adding incremental reads, etc. Once all the configurations are complete, the flow can move to a publishing and syncing step. Before this step, the connector is only configured as part of a connector builder project. To make this connector available and ready to use in actual connections, the present connector builder allows the user to publish the connector. This captures the current state of the configuration and makes the connector available as a custom connector within the current platform workspace. As shown in GUI 260 of FIG. 2D, the present system may enable the connector builder to set up a connection between a source and a destination based on user input.

With the GUIs shown in FIGS. 2A-2D, the following steps are completed:
Configured a production-ready connector to extract currency exchange data from an HTTP-based API:
   Configurable API key, start date and base currency;
   Incremental sync to keep the number of requests small;
Tested whether the connector works correctly in the connector builder;
Made the working connector available (e.g., publish) to configure sources in the workspace;
Set up a connection using the published connector and synced data from the Exchange Rates API.

### Technical Features

The present disclosure offers a technical solution of generating a connector (e.g., low-code connector) using an interactive and intelligent tool to achieve technical benefits/goals including but not limited to, (1) implementing the connector without manual configuration (e.g., writing the yaml configuration files) by connector users (e.g., developers), for example, by using one or more AI models associated with AI service, and (2) interactively building, configuring, and validating connectors by connector developers.

In some embodiments, the present disclosure may also provide one or more of tools, functionalities, instructions to migrate existing connectors to low-code connectors, perform low-code connector control (e.g., version and migration control), expand the coverage of low-code connectors to various types of applications, improve the regression test framework to ease troubleshooting processes, deploy the connector builder/generator to cloud, customize connectors in cloud, etc.

Various technical features are needed to achieve the above-mentioned technical benefits. Table 1 below lists some example technical features. In some embodiments, these features can be achieved in various phases as shown in Table 1, for example, allowing users to write the YAML file, enabling configuration, setting up basic static UI features, and/or setting up advanced UI features in each different phase. Particularly, in some embodiments, an AI assist subsystem and/or user connector contribution feature may be applied to minimize user operations, increase efficiency and accuracy, and improve user experience.

TABLE 1
Technical features

| | | |
|---|---|---|
| Feature | Description | Requirements |

Write YAML, test requests

| | | |
|---|---|---|
| Importing and | Creating a connector | Connector developers can copy and paste |
| testing a low-code | using YAML and | a YAML file |
| connector | being able to test | Test requests in the UI |
| | using the side panel | Provide ways for a user to take (copy or |
| | UI. | export) the YAML file and submit through |
| | | Github for further testing, review, and |
| | | potential public release |
| Display responses | Display the response | Render response body |
| received by the | received by the | Render response headers |
| connector from the | connector to provide | Render HTTP error if any |
| API source | visibility on the | Responses must NOT be logged by the |
| | platform records | backend because they contain user data |
| | produced by the | |
| | connector | |
| Display requests | Display the request | Render URL |
| sent by the | sent by the connector | Render request body |
| connector to the | | Render request headers |
| API source | | Render request parameters |
| | | Requests must NOT be logged by the |
| | | backend because they can contain user |
| | | data |
| Display records | Display the records | Render records produced by the connector |
| produced by the | that were produced | Records must NOT be logged by the |
| connector | by parsing the | backend because they contain user data |
| | response received | |
| Submit requests | Enable submitting | Interactively submit HTTP requests to the |
| (e.g., HTTP | HTTP requests to the | API source by running the connector's |
| requests) to the | API source so the | read operation |
| API source | users/developers can | Backend server implements an API |
| through a server | test the connector | specified using OpenAPI |
| running the CDK | | |
| (e.g. Python CDK) | | |
| Display connector | Display connector | Render connector logs after submitting a |
| logs | logs to provide | request |
| | visibility on any | The logs should include any error |
| | errors and platform | encountered by the connector |
| | records produced by | The logs should show the Platform |
| | the connector | message produced by processing the |
| | | response |
| | | Sensitive information must not be |
| | | displayed |
| | | Requests, responses, and records must |
| | | NOT be logged by the backend because |
| | | they contain user data |

Configuration, test requests

| | | |
|---|---|---|
| Configuration UI | Create a | Global configuration view for configuring |
| with Global and | configuration-form- | things that affect the whole connector |
| Stream views for | based UI that is | Stream configuration view for configuring |
| configuring a | structured with a | things that affect one specific stream |
| connector | global view, stream | Sidebar that allows users to navigate |
| | views, and a sidebar | between global and stream views, and add |
| | to navigate between | new streams |
| Configurable | Enable configuring | Developer should be able to specify |
| request options | request parameters, | request parameters, headers, and body data |
| | headers, and body | to set on the HTTP requests as key-value |
| | data | pairs, for a given stream |
| | | Request options are not configured |
| | | globally (instead, it is per-stream), and |
| | | configuration of request options between |
| | | streams is not linked |
| | | Defining global request options or |
| | | multiple shared request options, and |
| | | Link request options to streams |
| Configurable field | Enable extracting | Developer can specify a response json |
| pointer | records from HTTP | path to the record data (e.g., data to be |
| | responses using a | extracted for a given stream) |
| | field pointer | Field pointer is not configured globally |
| | | (instead, it is per stream), and pointer |
| | | configuration between streams is not |
| | | linked |
| | | Defining a global field pointer or |
| | | multiple shared field pointers, and |
| | | linking the field pointers to streams |
| Configurable | Enable configuring | Developer can select a single |
| authentication | the authentication | authentication type that is used for the |
| | mechanism for the | whole connector |
| | connector | Configuring different authenticators |
| | | for different streams |
| | | Authentication values that hold secrets |
| | | must come from user configuration fields; |
| | | they cannot be statically set by the builder |
| | | This prevents secrets from being |
| | | saved in the connector configuration |
| | | output |
| | | To make this clear, when an |
| | | authentication type is selected, user- |
| | | configuration fields should be |
| | | automatically created, and references |
| | | to these fields should be put in the |
| | | authentication configuration fields, |
| | | which are non-editable |
| Copying/duplicating | Copy a stream | A button can be clicked to copy an |
| stream | configuration to a | existing stream configuration into |
| configuration | new stream | a new stream |
| | | All values for each configuration in the |
| | | stream are copied into the new one so that |
| | | users do not need to repeat any work |
| Configurable | Enable configuring | Developer can select which paginator a |
| pagination | the pagination | given stream uses |
| | mechanism for the | The paginator fields can be configured |
| | connector streams | Paginator is not configured globally |
| | | (instead, it is per-stream), and paginator |
| | | configuration between streams is not |
| | | linked |
| | | Defining a global paginator or |
| | | multiple shared paginators, and |
| | | Linking the paginators to streams |
| Configurable | Enable configuring | Developer can select which stream slicer a |
| stream slicers | the stream slicers | given stream uses |
| | for the connector | The stream slicers fields can be configured |
| | streams | Stream slicer is not configured globally |
| | | (instead, it is per-stream), and slicer |
| | | configuration between streams is not |
| | | linked |
| | | Defining a global stream slicer or |
| | | multiple shared stream slicers, and |
| | | Linking the stream slicers streams |
| Define user- | Define fields and | Developer can add/edit/remove user- |
| configuration | their types, which | configurable fields, and define their types |
| fields | will be configured | (e.g., string, number, boolean, etc.,) |
| | by the end-user of | User configuration field values can be |
| | the connector | referenced and interpolated in the values |
| | | of global/stream components (e.g., user- |
| | | ${user_id}) |
| | | These user-configuration fields determine |
| | | what is shown in the Test Settings menu |
| | | User field IDs can be auto-set to some |
| | | value (e.g., snake case version of field |
| | | name), and always display the field name |
| | | for interpolation |
| Copy stream | Allow users to copy | |
| components | a fully configured | |
| | component from one | |
| | stream to another | |
| Add a button to | Allow users to start | |
| wipe out all | from scratch by | |
| changes in the | clicking a button | |
| connector builder | | |
| UI | | |
| Undo | Allow undoing any | Developer should be able to undo an |
| functionality | action taken in | action he/she took in the UI to correct |
| | the UI | mistakes |
| Configurable | Enable configuring | |
| backoff | the backoff strategy | |
| strategy | for the whole | |
| | connector | |
| Configurable | Enable configuring | |
| error | the error handler for | |
| handler | the whole connector | |
| Configurable | Enable configuring | Developer can configure fields that should |
| transformations | the transformations | be added to each record |
| | for a stream | Developer can configure fields that should |
| | | be removed from each record |
| Configurable | Enable configuring | |
| checkpoint | the checkpoint | |
| interval | interval for a stream | |
| Configurable | Enable configuring | |
| record filter | the record filter | |
| | for a stream | |
| Configurable | Developer can | Developer can select the streams from a |
| connection | specify which | menu to be used for check operations |
| checker | streams a check | In the above minimum viable product |
| | operation should | (MVP) iteration, this will be automatically |
| | test for | set to the first stream |
| Yaml to UI | Support switching | User/Developer can switch from the |
| | from yaml editor to | YAML editor to a configuration UI, and |
| | configuration UI | all of the inputs will be filled in with fields |
| | without losing any | from the yaml editor |
| | values | Switching back from the UI to YAML |
| | | editor should also preserve field values. |
| | | This may result in *refs disappearing |
| | | when the frontend does create or manage |
| | | those |
| | | Require a builder server endpoint that |
| | | validates and resolves references in the |
| | | manifest, and returns the dereferenced |
| | | manifest to the UI |
| Shared | Allow stream- | From the feedback on the P1 |
| stream | specific | Configuration MVP iteration, determine if |
| configurations | configurations to be | it is necessary to allow stream-specific |
| | defined globally and | configurations (e.g., paginators, slicers, |
| | shared or linked | pointers) to be defined globally and/or be |
| | between streams | linked together across streams |
| | | Implement based on the feedback |
| | | Configurations can be defined globally, |
| | | and specific fields can be “overridden” by |
| | | streams |
| Generate a set of | | Generate connector definition YAML file |
| configuration files | | Generate schema files |
| defining a low- | | Generate spec file - combine into a single |
| code connector | | YAML file |
| Automatically | Low-code connector | Generate schema file by parsing response |
| generate schema | generator should | |
| file from a parsed | automatically | |
| response | generate the stream | |
| | schema by parsing | |
| | the response | |
| Generate catalog | Low-code connector | Generate a catalog file describing the |
| | generator should | connector's streams |
| | automatically | |
| | generate the catalog | |
| | file describing the | |
| | connector's streams | |
| Generate a docker | Low-code connector | Generate a docker image that can be |
| image | generator should | imported by operations support system |
| | build a docker image | (OSS) platform |
| | that can be imported | |
| | into OSS | |
| Connector | Enable developers to | Developer can use a custom Python class |
| developers can | use custom | instead of a built-in component |
| inject custom code | components (e.g., | The generated docker image imports |
| in a low-code | implemented in | custom code defined by the developer |
| connector if | Python) | |
| needed | | |
| Generate | Generate expected | Record output records |
| connector snapshot | records to be used in | Update acceptance-test config to |
| test | acceptance tests | reconcile output records with |
| | | snapshot records |
| Schema inference | Infer the stream | Detect schema by introspecting the |
| | schema from the | records |
| | records | Warn about a mismatch between detected |
| | | and user-defined schemas |
| Additional | | Should be able to search for a stream |
| features | | Should display a preview of configuration |
| | | fields |
| | | Should be able to save a connector and |
| | | deploy it in workspace |
| | | Should be able to upload an icon for a new |
| | | connector |
| | | Should be able to navigate to the builder |
| | | through the Platform web UI - |
| | | connector/sources page |
| | | Should be able to choose between adding |
| | | or creating a new connector |
| | | Developer can test requests with an input |
| | | state |
| | | Developer can choose between submitting |
| | | a GET or a POST request |
| | | Developer can configure how to handle |
| | | errors |
| | | Validate if values entered into Primary |
| | | key/Cursor field/Pointer |
| Create, read, | Users can see and | List out all connectors built with the |
| update, and delete | manage all | connector builder |
| (CRUD) UI for | connectors built with | Edit existing ones |
| connector builder | the connector builder | Delete existing ones |
| connectors | | Create new ones |
| Fork/load | Users can see which | One-click (e.g., fork button) operation |
| existing | connectors are | Pre-fill testing values from an existing |
| connectors | compatible with the | source that was used for configuring the |
| | connector builder, | connector |
| | and load the | |
| | connectors in the | |
| | connector builder | |
| Modify existing | Users can make | Edit prefilled configuration parameters of |
| connectors | changes to the | existing connectors |
| | connector forked in | Create new, custom connector based on |
| | the connector builder | editing existing connector |
| | | Publish the new connector in workspace |
| | | Users can choose to use custom |
| | | connectors built on the catalog without |
| | | needing to manually recreate them |
| Contribute | Allow users to place | One click operations |
| connectors | custom connectors | Difference between custom connector and |
| | created from forked | existing connector is submitted for |
| | existing connectors | approval |
| | in the connector | Custom connector is contributed upon |
| | builder back to the | system approval, merge, and release |
| | catalog | |
| Manage | | After a connector contribution, users can |
| contributed | | switch back to using the latest catalog |
| connectors | | version with little-to-no effort |
| | | Easy deletion/archive of unused custom |
| | | connectors |
| | | No need for users to re-generate or paste |
| | | user access token on each contribution |

### Overall Implementation

The main goal of the present platform is to provide one or more UIs that allow users (e.g., developers) to produce a connector in an interactive and guided way (e.g., interactive application). In some embodiments, the UI(s) described herein is a connector builder UI. It is an intuitive UI on top of the low-code YAML format and can be used to build connectors for synchronization within the same workspace directly from within the UI. The present platform proposes to use the connector builder UI to iterate on users' low-code connectors.

As shown above, in Table 1, the implementation of the present platform may be split into multiple phases such that the application can be incrementally built and adjusted based on user feedback. In some embodiments, the implementation may include three phases.

### Phase 1—Testing Requests

In the first phase, the present platform focuses on addressing the problem of debugging and iteration feedback loop. This provides an intermediate state that allows users to continue to manually write the yaml configurations or adapt to a simplified iteration process (e.g., without manipulating the development environment).

In some embodiments, in the first phase, the present platform allows users to:
write YAML configuration code directly in a browser,
test requests for their streams through a single click (e.g., button, tab),
view HTTP requests and responses, resulting records, and connector logs displayed in one or more UIs.

In some embodiments, in the first phase, the present platform may generate an in-browser YAML editor and a panel (e.g., a right-side panel of the prototype), along with a stream selector, URL, test button, and raw JSON/results/logs panels.

In some embodiments, from this first phase, the present platform can provide an integrated development environment (IDE) in the browser for a connector builder. In this phase, the present platform also benefits as it implements and validates the end-to-end infrastructure of the application, which requires at least a UI as well as a server to accept requests, execute CDK commands, and return the results back to the UI.

### Phase 2—UI Configuration

In the second phase, the present platform focuses on another main problem of removing the need to hand-write YAML configuration files, by offering intuitive UI forms instead.

In some embodiments, in the second phase, the present platform allows users to:
configure a connector by filling out forms in the UI;
select from an enumerated list of the implementation of various framework components (e.g., authenticator, paginator, stream slicer, record selector, etc.). In some embodiments, each selection along with predefined structures and sub-fields will be presented to users as a response;
configure request parameters and headers globally or per-stream;
define the configurable fields that end-users of a connector will need to fill out in order to use the connector; and
export the connector as YAML configuration files to enable building a docker image locally. The docker image can be added as a connector to the present platform.

With the functionalities described herein in the second phase, the present platform allows users to configure a functional low-code connector that can fully use the builder UI, without the need to manually write any yaml configurations. The output of the application in this state will still be YAML files that the user can export, thereby allowing users to add the connector to the system using the existing process.

### Phase 3—Polishing End-to-End Experience

In the third phase, the present platform focuses on various improvements to the overall experience of using UI(s) of the connector builder, mainly to reduce or eliminate the manual steps that are required for the users outside of the builder UI.

In some embodiments, in the third phase, the present platform allows users to:
automatically infer stream schemas from API responses, reducing the need to manually write code, which is extremely important in connector building;
automatically generate a catalog that describes the streams available in an API from the UI. A catalog is a collection of connectors offered by the present platform, which does not include custom connectors created by end-users (unless contributed back with the user connector contribution feature as described below)
navigate to the connector builder from the main UI of the present platform;
save a connector built from the low-code builder directly into the system instance on which the connector is running, so that the connector can be used immediately for data synchronization;
generate connector snapshot tests, such that record snapshots in acceptance tests can be used to verify an output when there are changes to the connector;
configure which streams should be used in the “check connection” operation in the UI;
add end-to-end (E2E) tests of the application to ensure reliability and help prevent regressions;
embed the testing side panel in the connector form page so that users can test out any connector;
add check/discover/spec testing functionality to the testing panel; and
add the display of all slices for a stream (generated from parsing the connector configuration).

In some embodiments, at the end of this phase, the low-code connector builder will be fully integrated into an application (e.g., a web application) of the present system, allowing users to navigate to it from the sidebar, build a connector, and save the connector to their workspace without having to leave the UI. As a result, any user can build a connector without using a terminal, without modifying any files locally, and/or without having any knowledge of a CDK (e.g., Python CDK).

As discussed above, the present platform may be implemented in three phases: testing requests, UI configuration, and polishing the end-to-end experience. Each phase is associated with unique technical features/solutions. For example, in the first phase, the present system may focus on building a minimum viable product (MVP) around the testing iteration loop of a low-code connector builder, while in the other phases, the present system may apply an AI assist and/or user connector contribution subsystem to improve the connector creation process.

### UI-Based Configuration and Testing

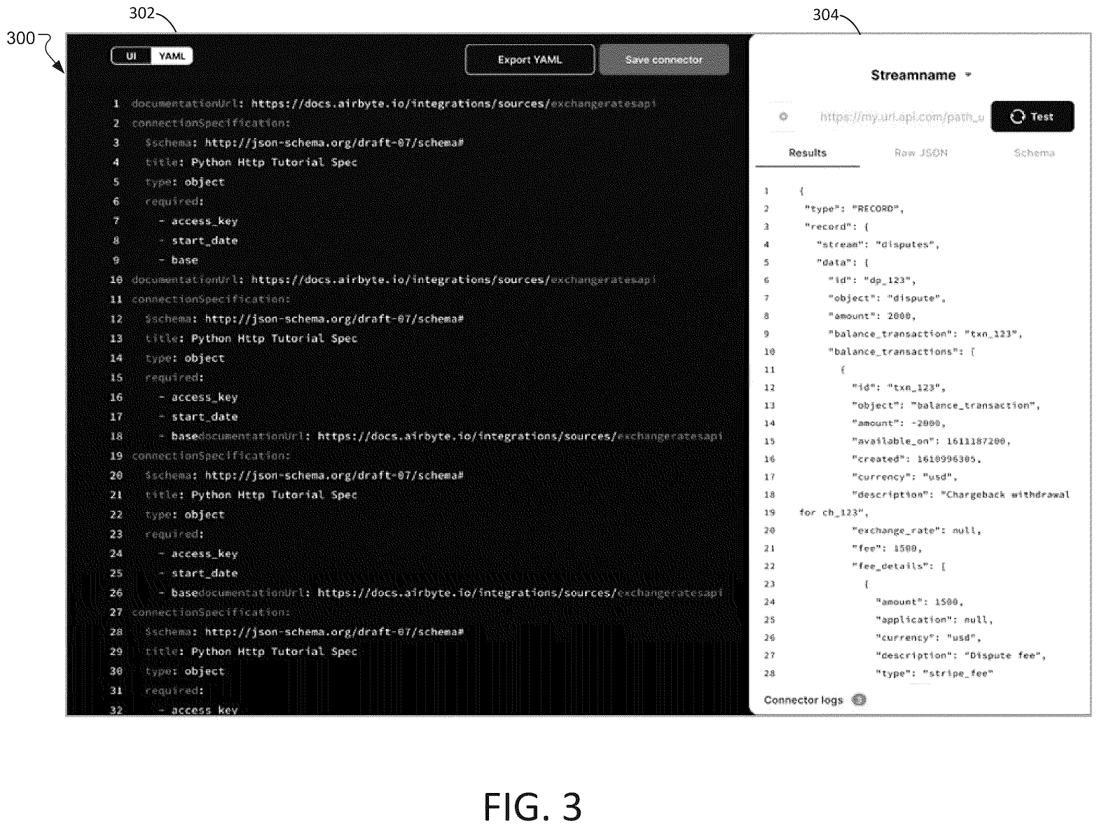

In some embodiments, the present platform may keep a small scope of the first phase (UI-based configuration and testing) by limiting users' capability to build a connector configuration through UI forms. FIG. 3 illustrates an exemplary output user interface component 300 in the first phase. UI 300 includes a “YAML” screen 302 and a right testing panel 304. As depicted, a user may need to handwrite a portion of a YAML file; however, UI 300 provides an improvement on the testing and iteration experience by including all the needed features in a single, unified space with well-formatted results scoped to individual streams. In some embodiments, UI 300 may also be embedded into an existing web application. This UI may be accessible through a specific path such as the “/builder” path in the URL (e.g., localhost:8000/builder).

The present platform may perform both backend and frontend tasks to implement functionalities in different phases.

### Backend Requirements

In some embodiments, the present system may combine the connector definition file (e.g., YAML file) and specification file (e.g., another YAML file) into a single file in the first phase, to allow the generation of a single text editing area without needing to manage multiple files. In some embodiments, the present platform may allow users to define the connector specification as a “spec” block in a connector definition file. To further enable this experience, the present backend system may also allow a “read” command to be executed using only a connector YAML definition and a config instead of the currently required schema file. The YAML definition may include the specification, and the config can be provided by the user through the UI.

In some embodiments, in the first phase, the present system may update the CDK to return raw JSON and connector logs in response. One feature of the present platform is to present the results (e.g., a list of messages), raw HTTP requests and responses, and connector logs to a user when testing a stream. Typically, the CDK returns the results from a read command but only logs the JSON requests/responses. In order to create a connector-builder-server that can provide the raw HTTP requests/responses and connector logs data to the frontend, the CDK of the present platform is updated to intercept the HTTP requests/responses, and then return those requests and responses along with a full log output in a structured object. The connector-builder-server can then return this output to the frontend for display.

A potential approach to update the CDK is shown below in Table 2. This includes a new method read_with_logs, which calls the existing read( ) command, but intercepts HTTP requests/responses and captures log messages to return in the ReadWithLogsOutput return object.

TABLE 2
Update CDK to intercept HTTP requests/responses

```
Class ReadWithLogsOutput {
  messages: Iterator[SystemMessage]
  httpObjects: Iterator[Tuple(request: JsonBlob, response: JsonBlob)]
  logs: Iterator[string]
}
def read_with_logs(
  self,
  config: Mapping[str, Any],
  catalog: ConfiguredSystemCatalog,
  state: Union[List[SystemStateMessage], MutableMapping[str, Any]] = None,
) -> ReadWithLogsOutput:
```

In some embodiments, the present system may set up a connector-builder-server to support generating and displaying the UI. In some embodiments, a “Test” button is included in the builder UI to replace users' manual commands (e.g., read) on the terminal. A backend HTTP server is therefore applied as a standalone deployment in the present platform, where the UI may perform a command when the user clicks the “Test” button. This feature can be discussed in terms of behavior and infrastructure.

### Behavior

In some embodiments, the endpoints of the server may be defined in an Open API specification (e.g., issue, PR), which can be used to generate a typescript client for the frontend and a server (e.g., Python server) for the backend. Here, Python is used so that the server can natively execute Python CDK commands. In some embodiments, the present platform may apply one of the frameworks (Flask®, FastAPI®) supported by an Open API generator to implement the Python server and help maintain changes to the API specification.

In some embodiments, the frontend of the present platform may convert the YAML file into a JSON blob, which is then passed to the server in a POST request. The server may use this input to read from a source and return the results, raw JSON requests/responses, and connector logs to the frontend for display. In some embodiments, the present system may perform the reading from a source either by executing the Python CDK “read” command or by creating a generic source that takes the yaml config as a parameter and calls its read_with_logs method (e.g., shown in Table 2).

Since the UI “Test” button is scoped to a single stream, the connector-builder-server may generate a configured_Catalog and use that generated configured_catalog in the read command. The configured_Catalog contains only the passed-in stream at the request time.

### Infrastructure

In some embodiments, similar to the server deployment, a connector-builder-server may be a standalone deployment in the present platform, and thus, the present platform supports the following changes (e.g., a non-exhaustive list used for illustration).
a dedicated module in the repository (repo), with a Dockerfile and build.gradle to define the logic to build a standalone docker image;
entry added to . . . /docker-compose.build.yaml so that the container is built properly for docker deployments;
entry added to . . . /docker-compose.yaml so that the container is deployed properly for docker deployments;
entry added to . . . /kube/resources/and changes to each of the . . . /kube/overlays/to ensure that the server is properly deployed in kube deployments;
Helm chart added to . . . /charts/to ensure that the server is properly deployed in helm deployments;
updates to . . . /build.gradle to ensure this image is included in the platform build;
unique port configured for the container (and a kube NodePort Service with that port for kube deployment if done in this phase); and
a step added to the CI that builds the connector-builder-server and runs unit tests on it.

In some embodiments, the server may only be called from certain web applications, and the networking configuration may be relatively simple. In some embodiments, a reverse proxy may be needed.

### Frontend Requirements

In some embodiments, the following frontend components, including embedded yaml editor and stream testing side panel, may be applied to implement the UI 300 shown in FIG. 3.

### Embedded YAML Editor

In some embodiments, the present platform may implement an embedded yaml editor component, for example, using the monaco-editor/react library (which powers VS Code). In other embodiments, the present platform may modify an existing CodeEditor component to implement the yaml editor component.

When a user first visits the editor, the present platform may load certain default yaml file values to the editor to help indicate the structure and fields that need to be completed by the user. When the user is editing the yaml file, the present platform may save the file to local browser storage. This allows the user's progress to be saved, such that the present platform is able to load the user's previous yaml file state if the user navigates away from or closes the page and then returns to it.

### Stream Testing Side Panel

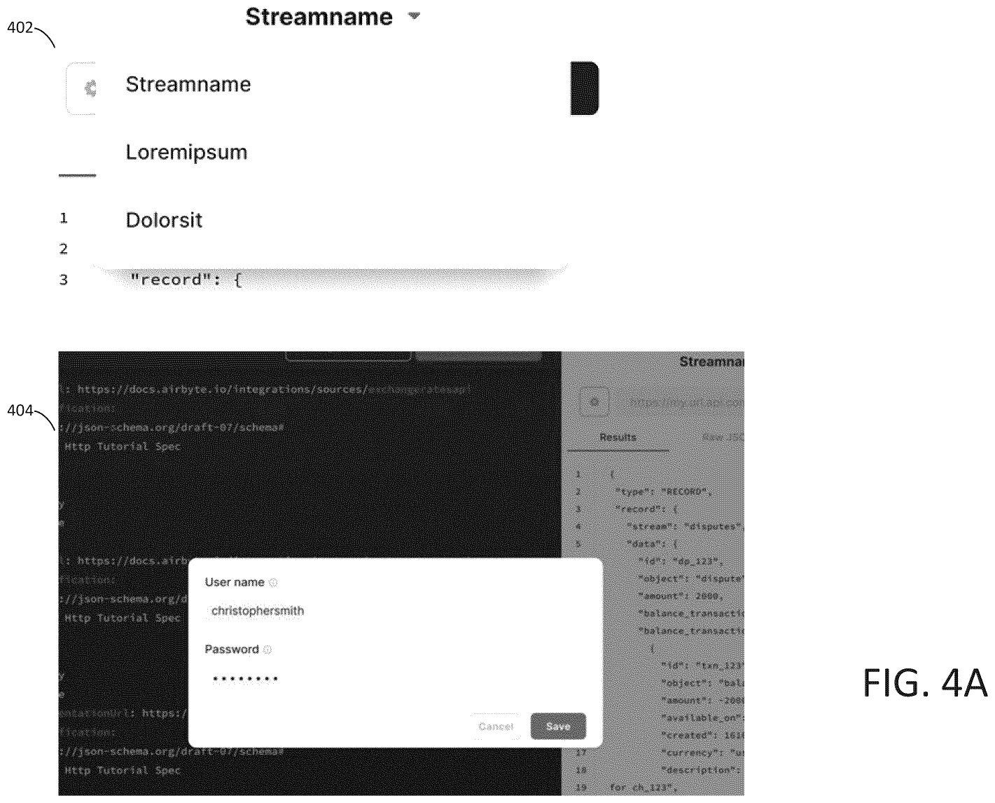

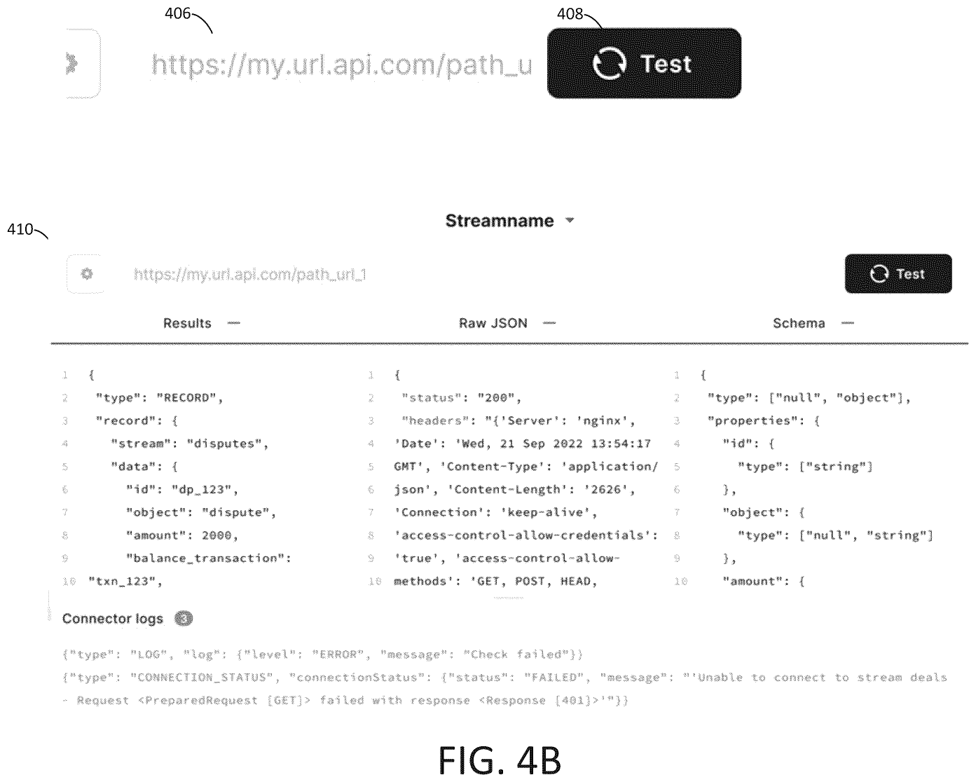

A stream testing side panel may include components shown in FIGS. 4A and 4B. FIG. 4A illustrates exemplary components including a stream name selector menu 402 and an optional config menu 404. The present platform may present the menu 402 to a user for selecting the stream to be tested. In some embodiments, the contents of menu 402 may be obtained from the parsing from the “streams” block in the yaml file. In other embodiments, a new endpoint may be added to the backend server, and this server may take in the yaml file and return a list of streams for menu 402. It should be noted the dropdown menu is used for illustration, which can be other forms such as text input. In some embodiments, the stream selected from menu 402 may be passed to the backend server along with the yaml file in response to a “Test” button (in FIG. 4B) being clicked.

While FIG. 4A depicts a config menu 204, it is optional. This menu is used to provide configuration inputs for the YAML-editor in an intermediate stage. In a preferred embodiment, the present platform may use a JSON text editor to provide the inputs.

FIG. 4B shows some other components of a side panel such as a URL display 406, a Test button 408, and a result display panel 410. In some embodiments, display 406 may be a read-only display of the URL that the request will be made to, which is auto-generated from the yaml file contents. In other embodiments, an endpoint may be added to the backend server that takes in the yaml file and a stream name and returns the full URL to display in 406, in particular, when a user is using string interpolation or special syntax in the yaml file.

Test button 408, when selected, submits a request to the backend server containing the yaml file and the stream name, causing the backend server to execute a read command for that stream and return the results/json/logs to the frontend.

Result display panel 410 may present the user with the resulting records, the raw JSON requests/responses, and the connector logs returned by the backend server. As depicted, result display panel 410 may include URL display 406 and Test button 408.

In different phases, different display panels may be presented to a user. For example, in the third phase, a schema panel may be presented to the user once auto-schema-detection is in place. In some embodiments, individual panels may be expanded or collapsed to facilitate user operations.

### Data Protection Consideration

In addition to the above requirements, the present platform may also take into account data protection. One consideration is about storing user credentials that are entered into the configuration menu when testing a stream. Since the present platform only stores credentials temporarily in the web application memory and then passes it internally to the connector-builder-server, the credential is securely protected.

Another concern is the exposure of source record data. As long as the record data is not stored in log files or otherwise is persistent anywhere, it is safe to display this record data in the web application since it is the data that the user owns or has access to.

### Execution Plan

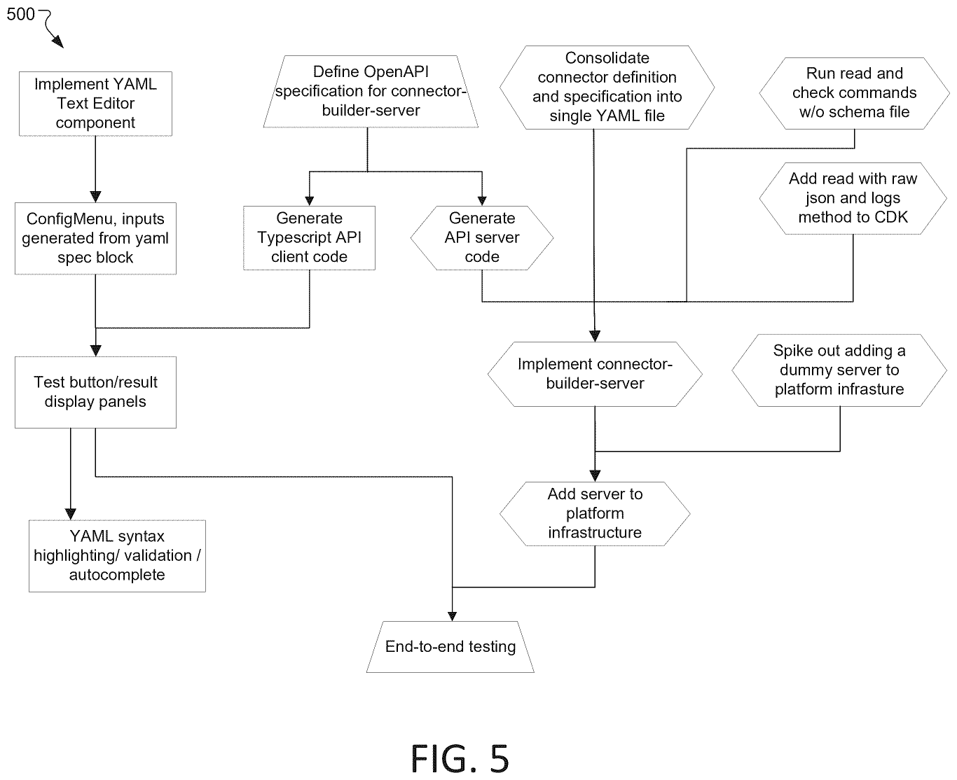

FIG. 5 illustrates an exemplary execution plan 500 in the first phase (UI-based configuration and testing). An execution plan may define how the present approach is implemented, and may also address the monitoring and controlling needed to implement the functionalities of the present approach. In FIG. 5, frontend tasks are depicted in rectangular boxes, backend tasks are depicted in hexagon boxes, and shared tasks are depicted in trapezoid boxes. The frontend tasks (e.g., implementing yaml editor component 502) and backend tasks (e.g., generating API server code 504) are described above respectively in frontend and backend requirements, and the shared tasks (e.g., defining open API specification 506 and end-to-end testing 508) may be performed by either the backend server or the frontend server.

### AT Assist Subsystem

An AI assist subsystem enables the present connector builder to create a connector for a user either from a link (e.g., HTTP link) to a public document site or from an open API specification. When creating the connector, the AI assist subsystem also provides ongoing suggestions in the connector builder for possible parameters of the specified API. These parameters may include, but not limited to, base URL, authentication scheme, pagination strategy, primary key, record path, candidate streams, etc. An AI assist subsystem may be applied throughout the entire connector creation process (e.g., all three phases as described above). Put in another way, the AI assist subsystem may be applied in operations 102 through 108 of the connector creation flow as depicted in FIG. 1. The use of AI assist subsystem is also irrelevant to how a connector is created, that is, the AI assist subsystem may be triggered to help create a connector in the connector builder regardless whether a user selects importing a YAML manifest, loading an existing connector, or starting from scratch (e.g., 204, 206, or 208 in FIG. 2A). In any case, in some embodiments, the AI assist subsystem may only be activated in response to receiving user input. This user input, however, may be very simple and include limited information, such as a name “Google Ads” or a prompt “I want to create a Google Ads connector.”

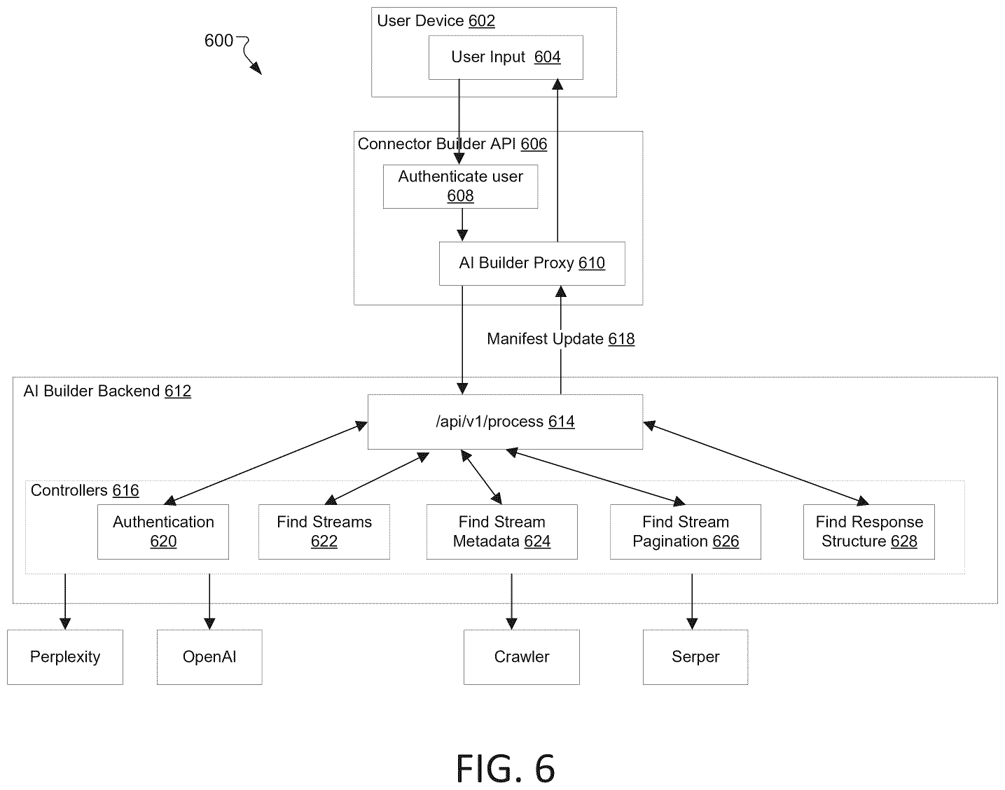

FIG. 6 illustrates an architecture overview 600 of an AI assist subsystem that provides AI assist features (e.g., ongoing suggestions). In some embodiments, the AI assist features may be powered by an AI service. The AI service is referred to as an AI builder service in the context of connector building, which can be provided by an AI builder backend server 612. For simplicity, the terminologies of AI service and AI builder service may be exchangeably used in the connector building description hereafter. The AI service may be reachable via a proxy (e.g., AI builder proxy 610) through a cloud server (e.g., AI builder backend server 612).

A user can interact with a connector builder UI (not shown) using a user device 602 associated with the user. For example, user input 604 may include an AI service request made by the user through a connector builder UI from user device 602. As depicted in FIG. 6, the user input 604 (e.g., including an AI service request) may be routed through a connector builder API 606 at the endpoint/api/v1/process 614 and then forwarded to the AI builder service provided by AI builder backend 612.

In some embodiments, the present platform may include connector builder UI and connector builder API, each of which may power cloud offering and/or deploy on user devices (e.g. 602) associated with the users. In response to receiving user input 604 (e.g., an AI service request), the connector builder UI may make a call to the connector builder API 606 to authenticate the user in 608. Once the user is successfully authenticated, the connector builder API 606 may use the AI builder proxy 610 to proxy the request to the AI builder service.

In some embodiments, the AI service may be closed source and available in a cloud product of the present system. In some embodiments, the present system may allow a user to interact with the connect builder UI (e.g., accessing the connector builder generate page) to request the AI service. For example, one or more buttons adjacent to one or more individual areas of a connector builder edit screen may be selected by a user to request the AI service. To serve the AI service request, the present system may make use of any combination of various AI tools such as Perplexity®, OpenAI®, Firecrawl®, or Serper® as depicted in FIG. 6, which will be further described below.

A user's request to the AI service typically includes an action the user requests to take place and/or the information that may help the AI service or the AI assist subsystem to perform the action. The action may include creating a connector, finding an authentication scheme, finding a pagination strategy, finding a primary key, finding a record path, finding possible streams, finding a stream path, etc. The helpful information may include one or more of a documentation URL, an open API specification URL, a stream name, a connector name, a current manifest used in the connector builder, the latest test read, etc. The AI service may return a response upon performing the requested action. The current manifest may include a YAML manifest loaded in the connector builder UI. In some embodiments, the response returned back from the AI service may be included as part of a manifest definition, which the connector builder reads and merges with the current YAML manifest.

As discussed above, the AI assist subsystem/AI builder service provides the present connector builder capability to create a connector from a link to a public document site or from an open API specification. The AI builder service provided by the AI builder backend 612 may include the important logic that transforms a public URL into a connector manifest (e.g., providing manifest update 618). The important pieces of logic, in some embodiments, may be exposed via controllers 616 that map to different AI service requests from one or more users.

### Controllers

A controller is a self-contained routine that generates a specific fragment of the manifest. In some embodiments, each of the controllers 616 takes the same inputs, for example, a documentation page, an open API specification URL, an existing manifest file, etc. The controllers 616 may take the entire existing manifest as input and use this input in various ways, such as performing pattern-match to determine how other streams fill out the manifest fragments. When a controller (e.g., one of the controllers 616) is used to generate a portion of a stream, the controller's input may also include the stream name.

In the API, controllers 616 may be invoked by a POST request made to the URL “/api/v1/process” of the endpoint 614, where the controller name is supplied as a controller parameter. Once the routines of the controllers are executed, the controllers 616 return a single union type referred to as a ManifestUpdate (e.g., 618). Each controller may identify one or more fields in the union type that the controller is able to deduce from the input provided to the controller, and set the value(s) in the identified field(s). In some embodiments, controllers 616 may also return metadata (e.g., a response ID) to be used for debugging and evaluation.

In some embodiments, controllers 616 may include but not limited to:
find_url_base: determine a base URL for the API;
find_auth: determine an authentication method;
find_streams: return a list of candidate streams;
find_stream_metadata: return metadata (e.g., path, HTTP method) for a stream;
find_stream_pagination: return a pagination strategy for a stream; or
find_response_structure: return a structure of a response for a stream.

A subset of the above-mentioned controllers 616 are depicted in 620, 622, 624, 626, and 628 of FIG. 6. In some embodiments, the present platform may also support one or more composite controllers, which internally invoke multiple other controllers to piece together a more complete manifest. For example, a composite controller may be a create-connector controller that creates a new connector from scratch, or a create-stream controller that creates a new stream from scratch.

Sequencing and caching can be essential in some cases, for example, when a controller relies on the outputs of other controllers to function properly. A controller of “find_stream_metadata” may need the base URL of the controller (i.e., the output of the “find_url_base” controller) to determine an appropriate stream API endpoint path. Additionally, there may be a significant amount of redundant tasks (e.g., scraping a documentation page), and the present platform may address this by caching controllers' inputs (e.g., using Redis) and coordinating the sequencing (e.g., with locks). For example, if a first controller and a second controller call the same expensive function, instead of repeating this call, the present system may put the second controller to wait until the routine execution of the first controller is complete and receive the result from the cache. This cache process will be described in more detail below.

### AI Tools

In some embodiments, the present platform may apply different AI tools/models) in the AI assist subsystem. These AI tools may be used to help configure the environment as well as perform other functionalities such as testing frameworks, and/or monitoring system performances and alerting anomalies. For example, Firecrawl® and/or Jina Reader® may be applied to crawl the web for documentation, and Serper® may be used when querying search engines in certain scenarios.

One or more large language models (LLMs) may be applied in the AI assist subsystem of the present platform. For example, an OpenAI® model (e.g., GPT-4o model) may be used to run integration tests, and OpenAI® Assistant's file search functionality may be suitable when scraped documentation is too large to fit in the context. Perplexity® can also be used to obtain generic metadata about an API having limited information (e.g., only application name and/or product homepage are available), or serve as a fallback (e.g., when there is a failure to generate an answer from documentation).

Additionally or alternatively, one or more LLMs (e.g., OpenAI® Assistants) can be created automatically by continuous integration/continuous deployment (CI/CD) for staging and production. As to telemetry, for example, the present system may use Langsmith® to collect traces. These traces contain individual calls to LLM tools (e.g., OpenAI®, Perplexity®). The calls may be grouped by controller(s) and tagged with the same metadata as application performance monitoring (APM) traces. In some embodiments, one or more LLMs (e.g., Openpipe®) may also be used to collect the same data for the purpose of fine-tuning a model. It should be noted that third-party AI tools and/or AI tools specifically designed for the present platform (e.g., based on publicly available AI models) may be deployed in the AI assist subsystem.

### Caching/Locking

In some embodiments, the AI assist subsystem of the present platform may use Redis® for caching in staging and production. For a local device, a disk cache under .cache may be used if a REDIS_URL is not provided.

In some embodiments, caching may be handled (e.g., using the @cache( ) decorator) to provide specific functionalities. For example, calls to the same function with the same arguments should be cached, and/or concurrent calls to the same function with the same arguments should be prevented (e.g., using a distributed lock). The concurrent calls may be blocked until a cached response is available, and the response will be returned. In some embodiments, a context manager (e.g., locked_cache( ) manager) may also be applied to provide the same functionality when a key needs to be constructed at function runtime.

Cache-busting ensures that users receive the most up-to-date version of resources (e.g., scripts, stylesheets) rather than stale, cached versions stored in intermediate caches. In the present system, a commit secure hash algorithm (SHA) is automatically incorporated into a cache key, such that new deployment can effectively invalidate the entire cache. The cache key can be a build_cache_key used by the decorator and context manager. An alternative helper build_state_key can also be used to avoid incorporating a version.

When needed, the entire cache can be disabled, and one or more private caches may be used. To achieve the functionalities described herein, the cache parameters may be configured in a specific way. For example, the default expiry parameter will be set so that scraped pages are cached for three days while anything else is cached for only three hours. As to the lock timeout parameter, requests will wait a maximum of 120 seconds for the distributed lock. By setting the retention time, the least recently used key will be evicted when it runs out of space.

### AI-Assistant Connector Creation Flow

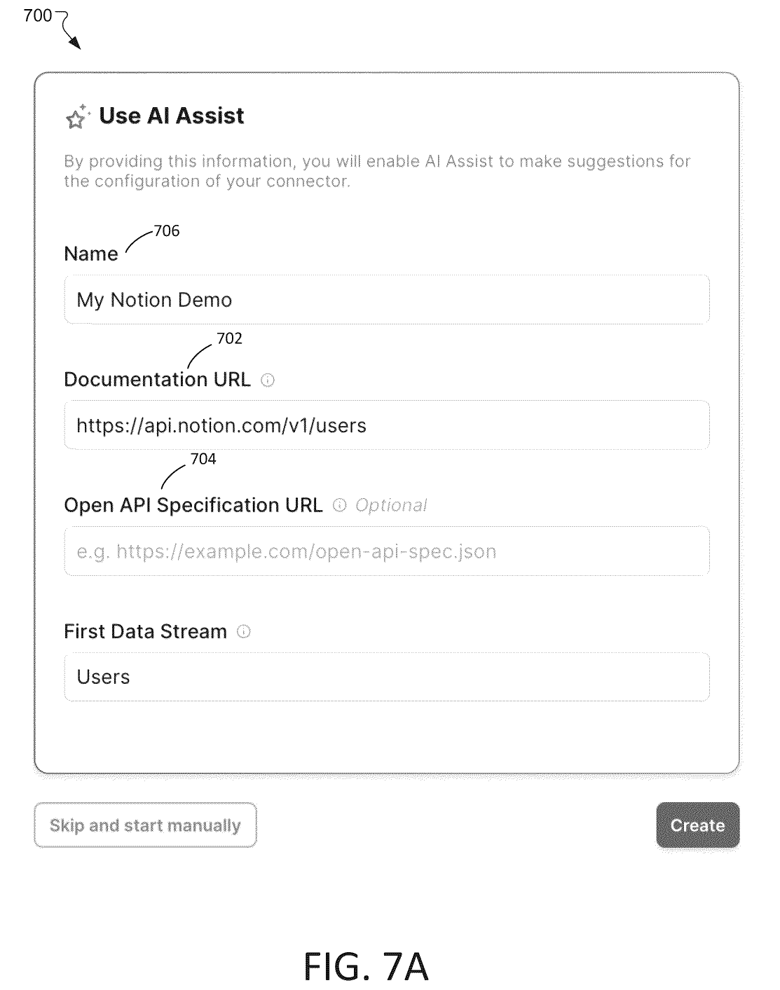

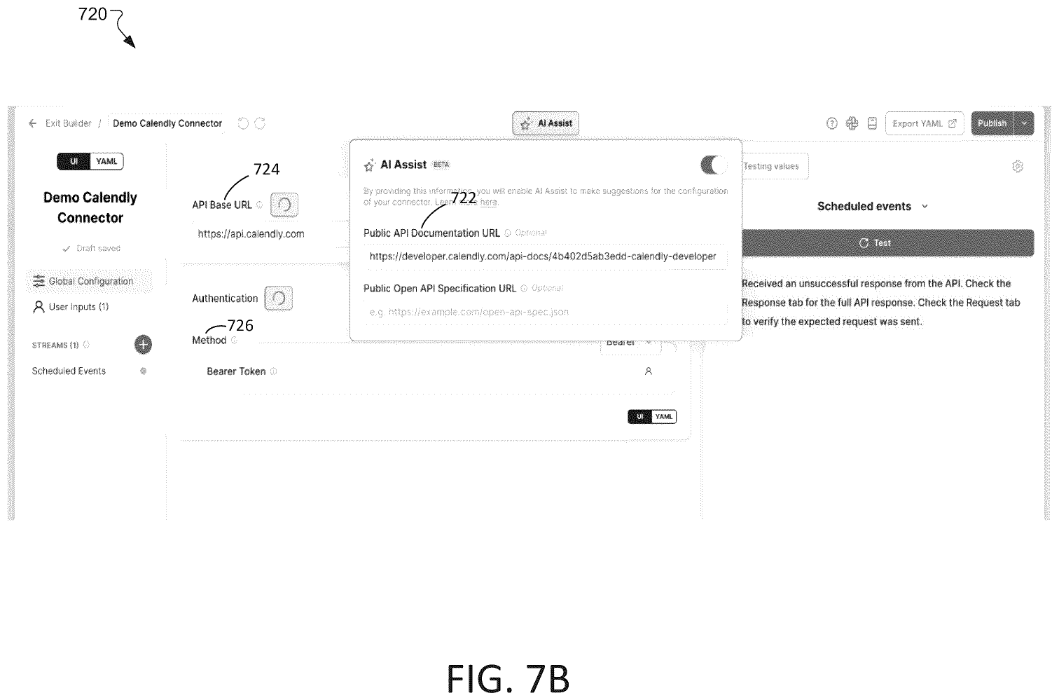

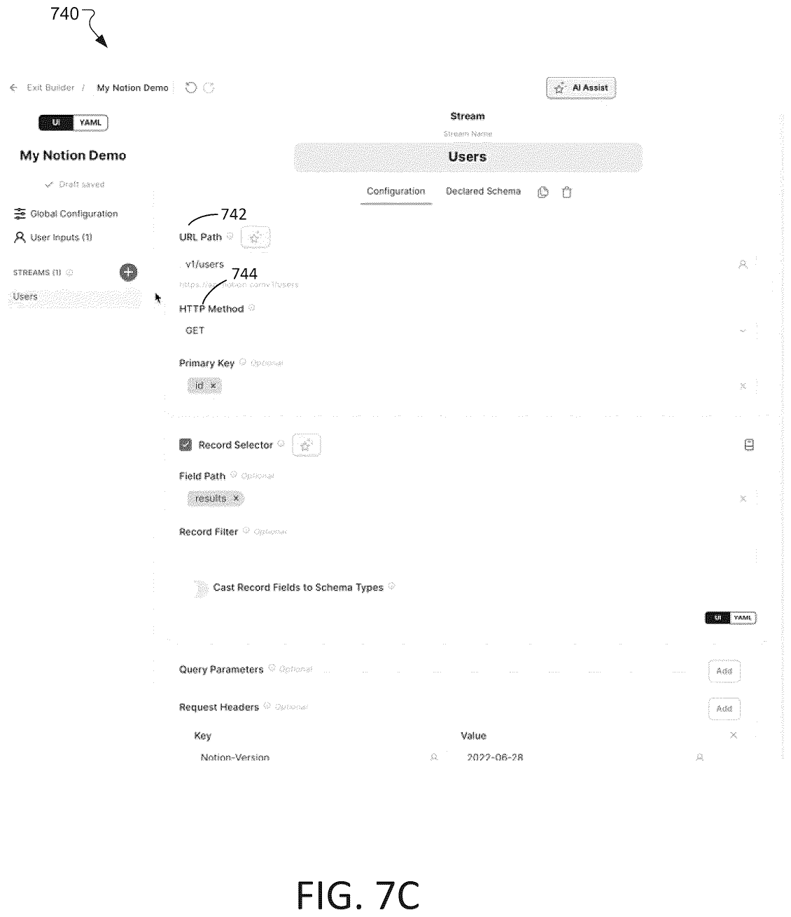

As described above, when creating a new connector, the AI assist subsystem can automatically prefill and configure various fields/sections and further provide intelligent suggestions to help fine-tune the connector configuration for a user. FIGS. 7A-7C illustrate an exemplary flow for AI-assistant connector creation. The user may interact with a connect builder UI, e.g., by accessing a connector builder generate page, to initiate an AI assistant/service to create a connector from a public document URL. In the GUI 700 of FIG. 7A, the user may provide a documentation URL 702 or an optional open API specification URL 704 from which the connector is intended to be created, as well as other information such as a connector name 706. Given the provided information (e.g., documentation URL 702), the AI assist subsystem or AI service can be utilized to automatically make suggestions for the configuration of the connector. As shown in GUI 720 of FIG. 7B, based on the user input of 702 and/or 706, AI assist may automatically scan the documentation identified by the public API documentation URL 722, identify and retrieve critical information from the documentation, and prefill in the configuration parameter fields/sections (e.g., API base URL 724, authentication methods 726) with suggested values. A user is also allowed to edit (e.g., accept, modify) these AI assist inputs in GUI 720. As the connector creation process progresses, in GUI 740 of FIG. 7C, the AI assist subsystem/AI service may provide suggestions for other fields and sections within the connector builder to facilitate and improve the connector creation process for the user. In the example of FIG. 7C, the configuration parameter fields such as URL path 742, HTTP method 744, etc., may be automatically populated with the intelligent suggested values from the AI assist.

Once a connector is created using an AI assist subsystem, this connector may be evaluated based on the comparison with one or more existing low-code CDK connectors. In some embodiments, the present system may evaluate a new connector by programmatically running the AI Assistant against a list of documentation URLs and comparing the output against known valid outputs, thereby ensuring an objective assessment of the quality of the generated output and understanding of the impact of changes.

### User Connector Contribution

User connector contribution is another unique feature of the present connector builder, which allows users to access/open connectors from a catalog of connectors, modify the connectors, and contribute the modified connectors back to the catalog. A catalog is a collection of connectors offered by the present platform. A custom connector created by an end-user using the connector builder is not included in the catalog unless the custom connector in the connector builder is contributed back to the system by the user.

When getting the connectors from the catalog, users may encounter issues or missing features. These issues should be quickly solved; however, it is difficult for the users to open the catalog connector in the connector builder because they generally do not know the directory containing the connector code and cannot determine whether a connector is compatible with the connector builder, much less find the YAML, configuration files in the connector's directory and manipulating the configuration files (e.g., upload the files to the connector builder). Additionally, users should not have to leave the connector builder UI to change, test, or sync a connector.

To address these problems, the present platform provides a unique user connector contribution feature that may allow the users to fork or load an existing connector from the catalog into the connector builder, modify the underlying definition of the connector, execute the connector in the user's workspace and, optionally, contribute the connector back to the catalog. The contributed connector may be taken as either a new connector or a modification to an existing connector.

### Forking Connector

One or more existing connectors may be loaded to the connector builder, for example, as a suggestion to a user initiating the creation of a custom connector based on the suggestion mechanism of the AI assist subsystem. In some embodiments, the present platform may allow manifest-only connectors to be loaded or forked. A manifest-only connector is a connector that includes manifest files only. The manifest files typically define the configuration and parameters required for a connector to function, which may include authentication methods, endpoints, data types, etc. For example, the manifest files may include YAML configuration files and optional components and icon configuration files. In some embodiments, when a connector is created based on manifest files, and the manifest files are uploaded to a connector metadata service bucket (e.g., a public file hosting service database) when the connector is published, this connector is marked as a manifest-only connector.

For a connector that is designed as manifest-only, a “fork button” may be enabled on a connector setup UI. In response to the selection of the “fork button” from a user, a new builder project is created in the database, and the new builder project includes at least the manifest definition associated with the loaded connector stored in the connector metadata service bucket. The user is directed to the connector builder page with the new builder project loaded, where the user may edit the parameters of the connector to create a custom connector.

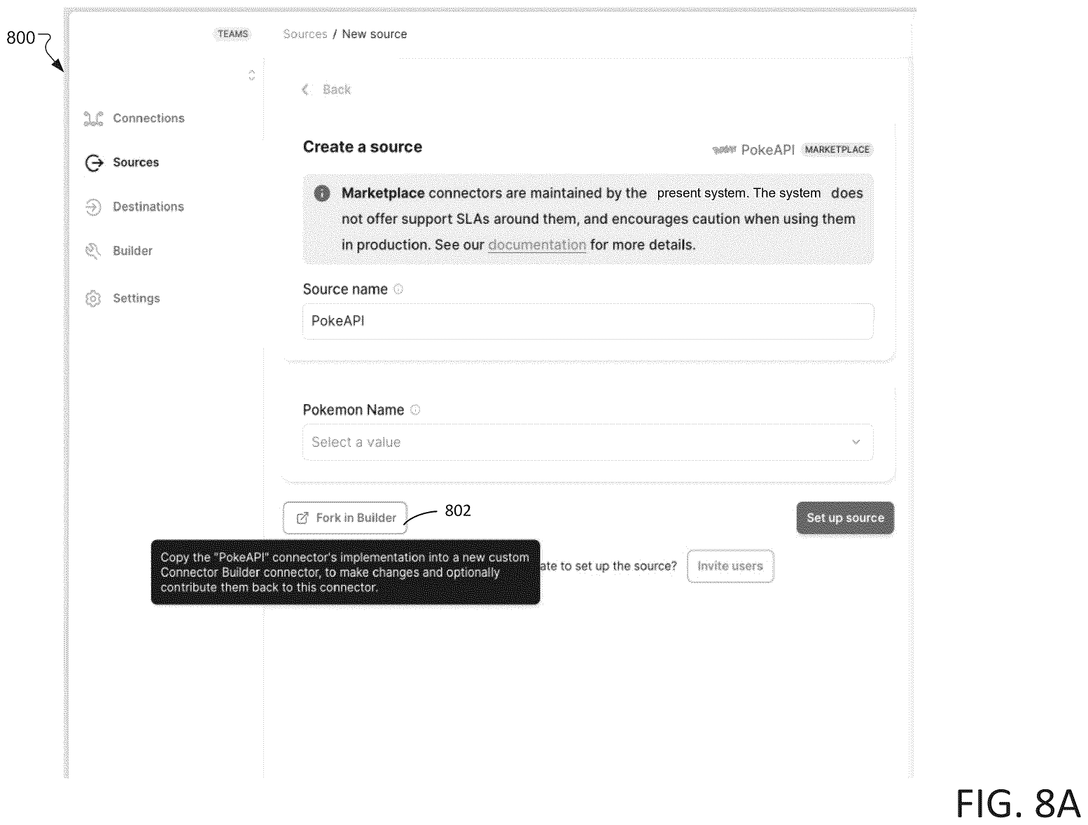

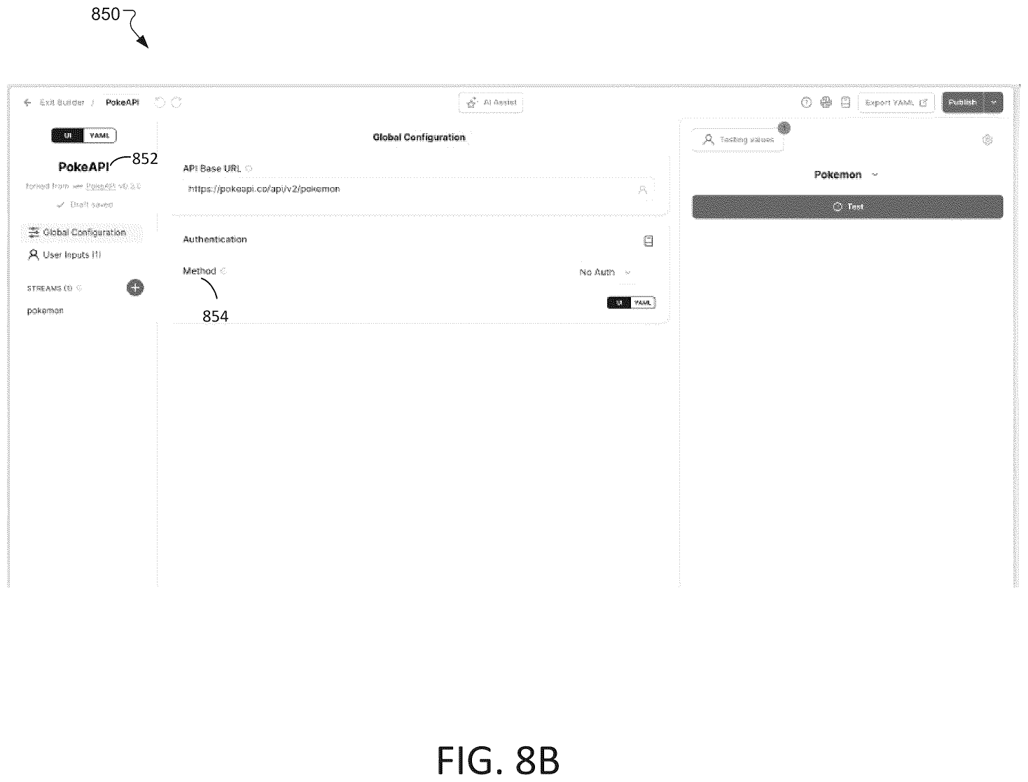

FIGS. 8A and 8B illustrate exemplary GUIs for forking an existing connector. In GUI 800 of FIG. 8A, a “Fork in Builder” button 802 is enabled, allowing a user to load an existing connector, e.g., “PokeAPI,” into the user's new custom connector builder. As shown in GUI 850 of FIG. 8B, the “PokeAPI” connector 852 has been loaded into the builder. Using GUI 850, the user can freely modify the “PokeAPI” connector to create a custom connector. For example, the user may modify the authentication method in 854. Once the custom connector is created, the user may choose whether to contribute this connector back to the system, as described below.

### Contributing Connector

The present platform may fork/load an existing connector (e.g., manifest-only connector) into the connector builder based on a user selection on the connector setup UI, receive user input (e.g., edition or extension) on the loaded connector, and create a new, custom connector in the connector builder for the user based on the user input. Once this new, custom connector is created, the present platform may allow this connector to be contributed back from the connection builder to the system (e.g., stored in the connector metadata service bucket). For example, when a user has successfully run a test read for all streams defined in the connector builder associated with a connector (indicating a custom connector is created), the user can choose to store this connector back to the system. In some embodiments, when publishing the connector (e.g., as described in step 108 of FIG. 1), the present system may allow the user to make the connector available in system connections for other users by contributing the connector to the system.

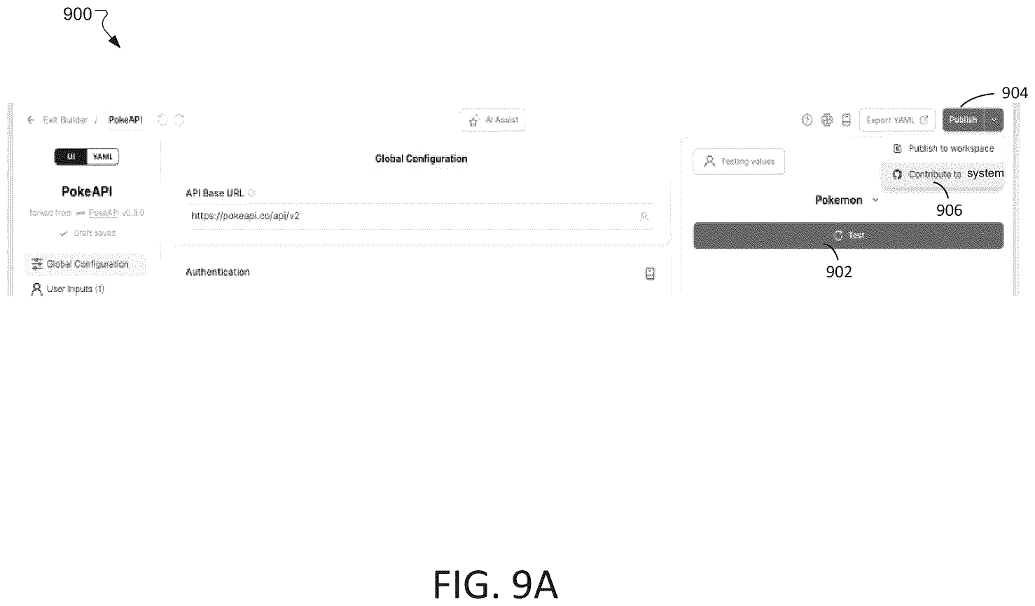

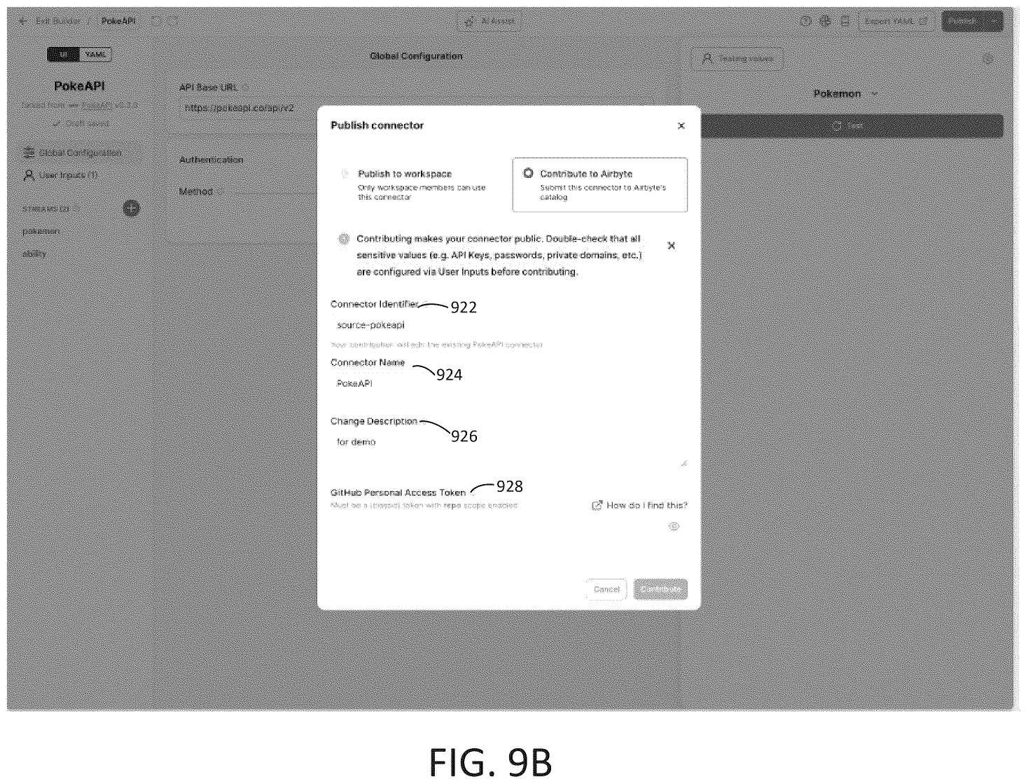

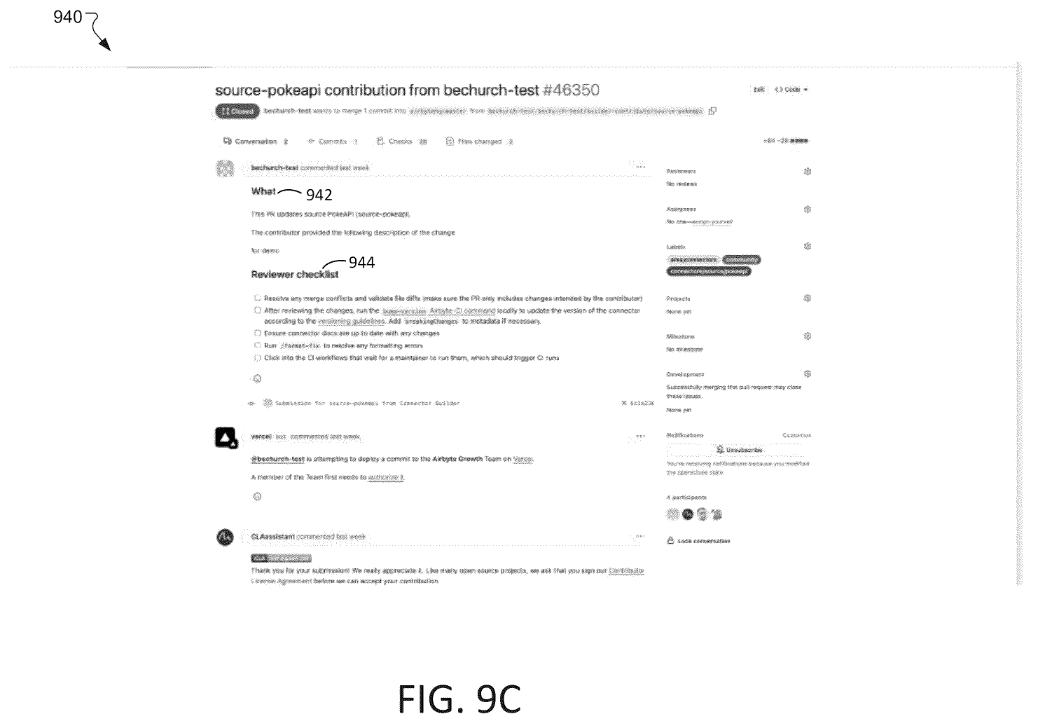

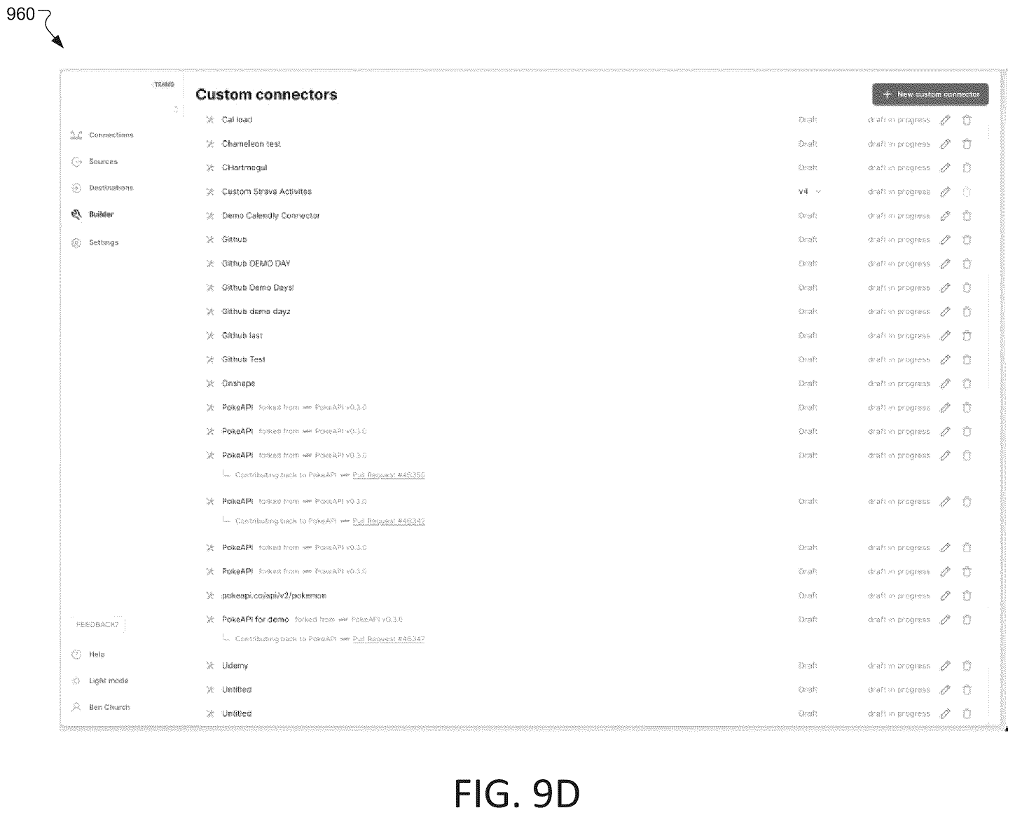

FIGS. 9A-9C illustrate an exemplary flow for contributing a connector. FIG. 9A shows a GUI 900 presented to a user for performing a contribution operation. The user may conduct a test run of the created “Pokemon” connector by clicking “Test” option 902, and choose to contribute this connector. To contribute the “Pokemon” connector, the user may first select “Publish” option 904 and then select “Contribute to System” option 906 in the dropdown menu. As a result, a modal (e.g., a dialog box shown in FIG. 9B) may be generated to request the user to provide relevant information such as a connector identifier 922 (e.g., source-github), a connector name 924, a description of the changes 926 (e.g., for a demo, adding an issue stream), a personal access token 928 (e.g., github access token), etc. Depending on whether the connector identifier already exists in the system, the present system may consider this connector as an “update to an existing connector” or “add a new connector.” If the connector identifier already exists, the user is notified of a connector update, and an existing manifest file is updated. Otherwise, the user is notified of a new connector being stored/contributed in the system. An exemplary manifest update is shown below in Table 3.

TABLE 3
Manifest Update

```
Class ManifestUpdate (BaseModel) :
  cdk_version : str = Field(default=LATEST_CDK_VERSION, exclude=True)
  url_base: str | None = Field(default=None)
  auth: HttpRequesterAuthenticator | None = Field(default=None)
  connection_specification: SpecConnectionSpecification | None =
  Field(default=None)
  stream_names: list[str] | None = Field(default=None)
  paginator: SimpleRetrieverPaginator | None = Field(default=None)
  stream_path: str | None = Field(default=None)
  stream_http_method: HttpRequesterHttpMethod | None = Field(default=None)
  record_selector: RecordSelector | None = Field(default=None)
  primary_key: PrimaryKey | None = Field(default=None)
```

Once the user selects “Contribute to System” option 906, an API request may be sent to the backend server (e.g., a connector builder server) to submit the contribution of the “Pokemon” connector. The present platform may approve, merge, or release a user's contribution request. In some embodiments, the connector builder server may determine if the connector identifier exists. If the identifier exists, the connector builder server may read existing manifest-only files (e.g., from github), and generate the new manifest-only files by updating the manifest files based on the user input. Next, the connector builder server may make certain function calls (e.g., to the github API using the user's github personal access token), which include one or more of forking the repo, creating a branch, creating/updating the manifest-only files at a unique directory path, creating a pull request from the branch, etc. In response to completing the calls, the connector builder may return a URL to the created/updated pull request to the user.

The present system may also review the submitted contribution. In some embodiments, the present system may automatically run tests on the users' connector contribution for accuracy. Additionally or alternatively, a manual test may be applicable. After a custom connector is contributed to the system, a user can choose to use the latest version of the connector in the system (e.g., another new model modified by another user). The present platform may also allow the user to delete or archive an unused custom connectors.

FIG. 9C illustrates an exemplary pull request 940 created by the connector builder for connector contribution. The pull request is often used to submit changes to the codebase to allow code review, collaboration and integration of new features, error fixes, etc. The key elements of the pull request may include a description, related issues, code changes, testing, individual review requests, etc. The description includes a summary of the changes. The related issues include the issues (e.g., links to the issues) that the pull request addresses. The code changes show the differences such as the addition, modification, or deletion. The testing element may include the information on tests and corresponding test results. For example, a description 942 and a reviewer checklist 944 (including fixed issues, testing, etc.) are included in the pull request 940.

FIG. 9D shows an exemplary list of connector builder projects 960. The list 960 may include the connectors that can be forked by users, as well as the connectors that are forked and then contributed back by the users.

### Flowchart

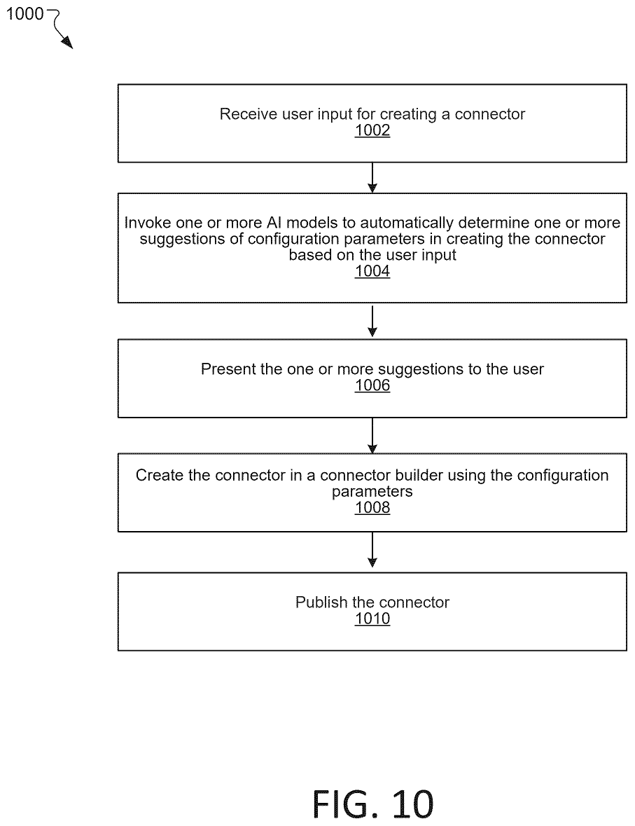

FIG. 10 illustrates an exemplary flowchart 1000 for creating a connector using an AI assist subsystem. In the present disclosure, a connector that describes functionalities for accessing (e.g., read, extract) data from an API or a database can be created in a connector builder. The connector may be a low-code connector created with reduced manual programming and without any manipulation of the development environment.

The method 1000 starts from receiving user input for creating the connector (e.g., API connector) at step 1002. The user input can be a user selection as to how to create the connector, for example, by importing a manifest file, loading an existing connector, or starting from scratch. The user input may also include a documentation URL or an open AI specification URL (e.g., 702, 704 in FIG. 7A), and such information may enable the AI assist subsystem to make suggestions for the configuration of the connector to be created. The user input may further include other information (e.g., a connector name) that is needed in implementing the connector creation method 100.

At step 1004, one or more AI models are invoked to automatically determine one or more suggestions of configuration parameters in creating the connector based on the user input. For example, one or more controllers associated with an AI service may be activated to identify one or more configuration parameter fields for which each of the one or more controllers is able to determine values based on the user input, and populate the values to the identified configuration parameter fields for displaying to the user. In some embodiments, one or more AI models may include Firecrawl® and/or Jina Reader® applied to crawl the web for documentation, Serper® used for querying search engines, OpenAI® model used to run integration tests, etc.

At step 1006, the one or more suggestions are presented to the user. The user may choose to accept a suggestion to continue the connector creation process, or to modify a suggestion to fit his/her own needs to create a custom connector. At step 1008, the connector is created in the connector builder using the configuration parameters. In some embodiments, the connector may also be tested. The requests and responses the connector will send to and receive from the API during development, and a detected schema may be applied to ensure that the connector can properly communicate with the API.

At step 1010, the connector is published for sync purposes and for use by others. Publishing the connector may include contributing the connector from the connector builder back to the system (e.g., storing the connector in a connector metadata service bucket). A user can choose whether or not contribute the user's custom connector. If the connector identifier associated with the connector has been included in the system, the connecter may be marked as an update of an existing connector. Otherwise, the connector may be stored as a new connector. Accordingly, a new manifest configuration file or an update of a manifest file will be stored.

It should be noted that the present platform uses an interactive tool to implement the functionalities described herein (e.g., operations of method 1000). Multiple GUIs are generated corresponding to the progress of the connector creation. For example, a user may simply select an option (e.g., by clicking a button or a tab) in a GUI of the connector builder to get authenticated or get AI assistance (e.g., in making suggestions of configuration parameters). Instead of determining how to configure a connector, the present system may provide the key parameters in a combined view and explicit visual manner in one or more GUIs, such that the user can directly reach and assess the multiple dimensions (e.g., authentication method, base URL) of the connector creation project. The user does not need to navigate to each view of each dimension to obtain corresponding information (i.e., no crawling of documentation). The present system generates the GUIs to interact with the user, for example, the present system can pre-populate a parameter such that the user can directly view and/or edit it on a GUI. In addition, the key operation tabs/buttons are placed in a distinct position of the GUI so that the user can easily use them to improve the experience of connector creation. For example, the tab “AI Assist” is located in the top center of a GUI (e.g., GUI 720 in FIG. 7B). This distinct position can guide the user to important features (e.g., reminding that AI can help make suggestions to the connector creation configuration), making the interface more intuitive and improving GUI usability. By placing certain icons in prominent positions to signal their importance and highlighting interactive elements (e.g., “Publish,” “Test” in FIG. 7B) to make them more discoverable, the present system enhances the visual hierarchy of icons in the GUIs, which further improves the user interfaces and help maintain the users stay in the unified views of the GUIs used in the present platform. The entire connector creation process can be accomplished in the GUIs of connector builder (e.g., connector builder UI) without a user navigating away to other systems.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

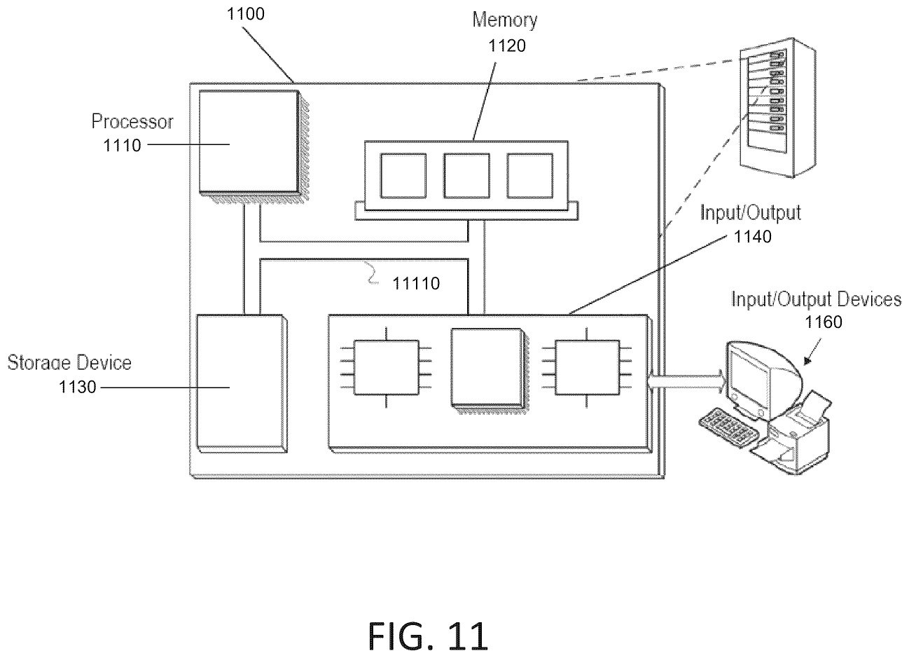

FIG. 11 is a block diagram of an example computer system 1100 that may be used in implementing the technology described herein. General-purpose computers, network appliances, mobile devices, or other electronic systems may also include at least portions of the system 1100. The system 1100 includes a processor 1110, a memory 1120, a storage device 1130, and an input/output device 1140. Each of the components 1110, 1120, 1130, and 1140 may be interconnected, for example, using a system bus 11110. The processor 1110 is capable of processing instructions for execution within the system 1100. In some implementations, the processor 1110 is a single-threaded processor. In some implementations, the processor 1110 is a multi-threaded processor. The processor 1110 is capable of processing instructions stored in the memory 1120 or on the storage device 1130.

The memory 1120 stores information within the system 1100. In some implementations, the memory 1120 is a non-transitory computer-readable medium. In some implementations, the memory 1120 is a volatile memory unit. In some implementations, the memory 1120 is a non-volatile memory unit.

The storage device 1130 is capable of providing mass storage for the system 1100. In some implementations, the storage device 1130 is a non-transitory computer-readable medium. In various different implementations, the storage device 1130 may include, for example, a hard disk device, an optical disk device, a solid-state drive, a flash drive, or some other large capacity storage device. For example, the storage device may store long-term data (e.g., database data, file system data, etc.). The input/output device 1140 provides input/output operations for the system 1100. In some implementations, the input/output device 1140 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1160. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1130 may be implemented in a distributed way over a network, such as a server farm or a set of widely distributed servers, or may be implemented in a single computing device.

Although an example processing system has been described in FIG. 11, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “of” should be understood to have the same meaning as “and/or” as defined above. For example, when separating items in a list, “or” or “and/of” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method for using an interactive and intelligent tool to generate a connector that facilitates communications between systems, the method comprising:
generating one or more first connector builder interfaces to receive user input for creating the connector;
invoking one or more artificial intelligence (AI) models to automatically determine one or more suggestions of configuration parameters used in creating the connector based on the user input;
generating one or more second connector builder interfaces to present the one or more suggestions of configuration parameters to the user for acceptance or modification;
creating the connector in a connector builder using the configuration parameters; and
generating one or more third connector builder interfaces to enable the user to publish the connector.

2. The method of claim 1, wherein the connector is a low-code connector with reduced manual programming and manipulation of development environment, and wherein the connector is configured to access data from at least one of an application programming interface (API) or a database.

3. The method of claim 1, wherein invoking the one or more AI models allows the connector to be created from at least one of a link to a public document site or an open API specification, and wherein invoking the one or more AI models to automatically determine the one more suggestions of configuration parameters comprises:
invoking one or more controllers associated with an AI service to identify one or more configuration parameter fields for which each of the one or more controllers is able to determine values based on the user input;
populating the values to the identified configuration parameter fields; and
presenting the one or more suggestions of configuration parameters by providing the populated values on the one or more second connector builder interfaces.

4. The method of claim 3, further comprising performing sequencing and caching to ensure the one or more controllers to function properly.

5. The method of claim 3, wherein the configuration parameter fields comprise one or more of a base URL, an authentication method, a list of candidate streams, metadata associated with a stream, a pagination strategy for the stream, or a structure of a response for a stream.

6. The method of claim 1, further comprising forking an existing connector to the connector builder, and wherein creating the connector comprises modifying the forked connector.

7. The method of claim 1, wherein generating the one or more third connector builder interfaces to enable the user to publish the connector comprises contributing the connector created in the connector builder to a database.

8. The method of claim 7, further comprising:
determining whether a connector identifier associated with the connector has been included in the database; and
marking the connector as a new connector or an update of an existing connector based on determining whether the connector identifier has been included in the database.

9. The method of claim 1, wherein the connector is created based on a selection from the user, the selection comprising one of importing a manifest file, loading an existing connector, or starting from scratch.

10. The method of claim 1, further comprising capturing a current state of creating the connector and performing synchronization based on the captured state.

11. A system using an interactive and intelligent tool to generate a connector that facilitates communications between systems, the system comprising:
a processor; and
a memory in communication with the processor and comprising instructions which, when executed by the processor, program the processor to:
generate one or more first connector builder interfaces to receive user input for creating the connector;
invoke one or more artificial intelligence (AI) models to automatically determine one or more suggestions of configuration parameters used in creating the connector based on the user input;
generate one or more second connector builder interfaces to present the one or more suggestions of configuration parameters to the user for acceptance or modification;
create the connector in a connector builder using the configuration parameters; and
generate one or more third connector builder interfaces to enable the user to publish the connector.

12. The system of claim 11, wherein the connector is a low-code connector with reduced manual programming and manipulation of development environment, and wherein the connector is configured to access data from at least one of an application programming interface (API) or a database.

13. The system of claim 11, wherein invoking the one or more AI models allows the connector to be created from at least one of a link to a public document site or an open API specification, and wherein, to invoke the one or more AI models to automatically determine the one more suggestions of configuration parameters, the instructions further program the processor to:
invoke one or more controllers associated with an AI service to identify one or more configuration parameter fields for which each of the one or more controllers is able to determine values based on the user input;
populate the values to the identified configuration parameter fields; and
present the one or more suggestions of configuration parameters by providing the populated values on the one or more second connector builder interfaces.

14. The system of claim 13, wherein the instructions further program the processor to perform sequencing and caching to ensure the one or more controllers to function properly.

15. The system of claim 13, wherein the configuration parameter fields comprise one or more of a base URL, an authentication method, a list of candidate streams, metadata associated with a stream, a pagination strategy for the stream, or a structure of a response for a stream.

16. The system of claim 11, wherein the instructions further program the processor to fork an existing connector to the connector builder, and wherein creating the connector is based on modifying the forked connector.

17. The system of claim 11, wherein, to generate the one or more third connector builder interfaces to enable the user to publish the connector, the instructions further program the processor to contribute the connector created in the connector builder to a database.

18. The system of claim 17, wherein the instructions further program the processor to:
determine whether a connector identifier associated with the connector has been included in the database; and
mark the connector as a new connector or an update of an existing connector based on determining whether the connector identifier has been included in the database.

19. The system of claim 11, wherein the connector is created based on a selection from the user, the selection comprising one of importing a manifest file, loading an existing connector, or starting from scratch.

20. A computer program product for using an interactive and intelligent tool to generate a connector that facilitates communications between systems, the computer program product comprising a non-transitory computer-readable medium having computer readable program code stored thereon, the computer readable program code configured to:
generate one or more first connector builder interfaces to receive user input for creating the connector;
invoke one or more artificial intelligence (AI) models to automatically determine one or more suggestions of configuration parameters used in creating the connector based on the user input;
generate one or more second connector builder interfaces to present the one or more suggestions of configuration parameters to the user for acceptance or modification;
create the connector in a connector builder using the configuration parameters; and
generate one or more third connector builder interfaces to enable the user to publish the connector.
